(19) United States
(12) Patent Application Publication
(10) Pub. No.: US 2010/0127848 A1
(43) Pub. Date: May 27, 2010

(54) SYSTEM, APPARATUS, METHOD AND SENSORS FOR MONITORING STRUCTURES

(75) Inventors: Gamal K. MUSTAPHA, Winnipeg (CA); Jason G. TEETAERT, Vancouver (CA); Alistair C. BURROWS, Winnipeg (CA); Gregory P. JAMAN, Langley (CA)

Correspondence Address: NEXUS LAW GROUP LLP, 1500 - 701 WEST GEORGIA STREET, VANCOUVER, BC, V7Y 1C6, CA

(73) Assignee: SMT Research Ltd., Winnipeg (CA)

(21) Appl. No.: 12/324,888

(22) Filed: Nov. 27, 2008

(51) Int. Cl. G08B 26/00

(52) U.S. Cl. 340/505

(57) ABSTRACT

A system, apparatus and method for monitoring structures is provided. The system includes a measurement acquisition unit having a first connection point for receiving a sensor unit and a second connection point that is electrically isolated from the first connection point when invoking the sensor unit. A measurement sensor for detecting moisture includes a pair of spaced apart conductors; and an impedance circuit in parallel with the conductors and having a finite impedance such that an impedance of the measurement sensor greater than the finite impedance indicates an impaired connection. A termination module includes a base attachable to a measurement sensor, and the impedance circuit. A moisture content measurement sensor includes: a pair of conductors in electrically insulating material; and electrically conductive probe supports attached to the conductors for receiving probes and forming electrical connections between conductors and probes. Eyelet rivets may be used as probe supports.

### BACKGROUND OF THE INVENTION

1. Field of Invention

This invention relates to civionics and, in particular, to detecting moisture, condensation, leaks, humidity, temperature, pressure and other physical features of structures, such as buildings, and structural materials thereof.

2. Description of Related Art

Detecting, measuring and monitoring moisture in building materials of buildings provides data and information that can be valuable in the construction, restoration, maintenance and appraisal of such buildings.

U.S. Pat. No. 7,142,123 to Kates discloses a method and apparatus for detecting moisture in building materials. Kates discloses a moisture sensor system that includes a plurality of sensor units located throughout a building which communicate with a base unit through a number of repeater units. When a sensor unit detects an anomalous condition, the sensor unit communicates with and provides data regarding the anomalous condition to the base unit directly or through a number of repeater units. At programmed intervals, the sensor unit also “wakes up” and sends status information to the base unit (or repeater) and then listens for commands for a period of time. The sensor units use wireless techniques to communicate with the base unit and/or repeater units. Each repeater includes a first transceiver for communications with a sensor unit and a second transceiver for communications with the base unit. The base unit communicates with a monitoring computer system, which contacts a building manager, maintenance service, alarm service, or other responsible personnel using one or more of several communication systems such as telephone, pager, cellular telephone and/or the Internet and/or a local are network. There may be multiple base units.

However, the system of Kates is limited to base units that are unable to perform measurements in the manner of a sensor unit, and is limited to sensor units that are unable to perform functions of a base unit such as communicating by wired communications with the monitoring computer system.

Kates also discloses an impedance sensor provided to an impedance probe configured as a pair of conductive strips; an impedance sensor configured to measure impedance using an impedance bridge in which the probe is one leg of the bridge; and an impedance probe configured as a flexible tape, which may have an adhesive and a peel-off layer on the back and/or front of the tape. However, the impedance sensors and impedance probes of Kates are limited in their useability and ease of manufacturing.

Canadian patent no. 2,583,006 to Vokey et al. discloses a moisture detection sensor having a first pair of exposed conductors mounted on an insulating substrate for detecting surface moisture and a second pair of penetrated conductors mounted on the insulating substrate to measure moisture content at selected probed locations. A diode guide arrangement allows a monitoring unit to monitor the exposed conductors for surface moisture and the penetrated conductors for moisture content by reversing polarity of the voltage across the conductors. However, the system of Vokey et al. is limited to separating surface moisture measurement from moisture content measurement.

### SUMMARY

The above shortcomings may be addressed by providing, in accordance with one aspect of the invention, a system for monitoring structures. The system includes a measurement acquisition unit having first and second connection points, the measurement acquisition unit being operable to receive at the first connection point a sensor unit electrically connected to the structure, the measurement acquisition unit being operable to receive at the second connection point an electrical connection to the structure, the measurement acquisition unit being operable to electrically isolate the second connection point from the first connection point when invoking the sensor unit so as to produce a measurement result for monitoring the structure.

The electrical connection may include a wired communications bus for wired communications with a monitoring center, the measurement acquisition unit being operable to communicate the measurement result to the monitoring center via the wired communications. The measurement acquisition unit may include a third connection point for receiving a distributed power wire, the measurement acquisition unit being operable to electrically isolate the second and third connection points from the first connection point when invoking the sensor unit so as to produce the measurement result. The electrical connection may include a distributed power wire for supplying power to the measurement acquisition unit, the measurement acquisition unit being operable to establish an auxiliary power source for powering the measurement acquisition unit while the measurement acquisition unit is electrically isolated from the distributed power wire. The measurement acquisition unit may be operable to communicate the measurement result via wireless communications, the measurement acquisition unit being operable to select, from among one or more available recipients, a recipient for receiving the measurement result from the measurement acquisition unit, the measurement acquisition unit selecting the recipient such that the number of transmissions required to communicate the measurement result to a monitoring center is minimized. The measurement acquisition unit may be operable to select the recipient so as to maximize signal strength of communications with the recipient if a plurality of the available recipients have associated therewith a same minimal number of transmissions required for communicating the measurement result from the measurement acquisition unit to the monitoring center. The measurement acquisition unit may be operable to set, in response to the measurement result, an amount of time to elapse before producing a subsequent measurement result. The system may include a plurality of the measurement acquisition units, the plurality of the measurement acquisition units comprising a first the measurement acquisition unit wherein the electrical connection comprises a wired communications bus for wired communications with a monitoring center, the plurality comprising a second the measurement acquisition unit being operable to communicate the measurement result via wireless communications to a recipient selected from among available the measurement acquisition units, the second measurement acquisition unit selecting the recipient such that the number of transmissions required to communicate the measurement result to the monitoring center is minimized. The second measurement acquisition unit may be operable to select the recipient so as to maximize signal strength of communications with the recipient if a plurality of the available measurement acquisition units have associated therewith a same minimal number of transmissions required for communicating the measurement result from the second measurement acquisition unit to the monitoring center. The structure may define one or more faces. The first measurement acquisition unit and the second measurement acquisition unit may be located adjacent one of the faces. The first measurement acquisition unit and the second measurement acquisition unit may be aligned for line-of-sight communication therebetween.

In accordance with another aspect of the invention, there is provided a system for monitoring a structure. The system includes: (a) measurement acquisition means for producing measurement results, the measurement acquisition means comprising first connection means for receiving a sensor unit electrically connected to the structure, the measurement acquisition means comprising second connection means for receiving an electrical connection to the structure; and (b) isolation means for electrically isolating the second connection means from the first connection means when invoking the sensor unit so as to produce the measurement results.

The measurement acquisition means may include wired communication means for communicating the measurement results via wired transmission and comprises wireless communication means for communicating the measurement results via wireless transmission. The measurement acquisition means may include internal powering means for powering the measurement acquisition means when invoking the sensor unit.

In accordance with another aspect of the invention, there is provided an apparatus for producing a measurement result to facilitate monitoring a structure. The apparatus includes: (a) a first connector for receiving a sensor unit electrically connected to the structure; (b) a second connector for receiving an electrical connection to the structure; and (c) a switch for electrically isolating the second connector from the first connector when invoking the sensor unit so as to produce the measurement result.

The apparatus may include a wired communication transceiver for communicating the measurement result to a monitoring center via wired transmission when a wired communications bus is connected to the second connector. The apparatus may include a third connector for receiving a distributed power wire for supplying power to the apparatus, the switch being operable to electrically isolate the second and third connectors from the first connector when invoking the sensor unit so as to produce the measurement result. The electrical connection may include a distributed power wire for supplying power to the apparatus, the apparatus further comprising an auxiliary power source for powering the apparatus when the switch is electrically isolating the second connector from the first connector. The auxiliary power source may include a capacitor. The apparatus may include a wireless communication transceiver for communicating the measurement result via wireless transmission. The apparatus may include a sensor circuit operable to selectively invoke a reference resistance, the apparatus being operable to receive a measurement sensor having a pair of spaced apart conductors and an impedance circuit electrically connected in parallel with the pair of conductors, the impedance circuit having a finite impedance.

In accordance with another aspect of the invention, there is provided a method of monitoring a structure. The method involves: (a) receiving at a first connector of a measurement acquisition unit a sensor unit electrically connected to the structure; and (b) invoking the sensor unit so as to produce a measurement result for monitoring the structure, wherein invoking the sensor unit so as to produce a measurement result for monitoring the structure comprises electrically isolating a second connector of the measurement acquisition unit from the first connector.

The method may involve receiving at the second connector a wired communications bus for communicating the measurement result to a monitoring center via wired transmission. The method may involve receiving at a third connector of the measurement acquisition unit a distributed power wire for supplying power to the measurement acquisition unit, and wherein electrically isolating a second connector of the measurement acquisition unit from the first connector when invoking the sensor unit comprises electrically isolating the second and third connectors from the first connector when invoking the sensor unit. The method may involve receiving at the second connector a distributed power wire for supplying power to the measurement acquisition unit, and wherein electrically isolating a second connector of the measurement acquisition unit from the first connector when invoking the sensor unit comprises establishing an auxiliary power source for powering the measurement acquisition unit. Establishing an auxiliary power source for powering the measurement acquisition unit may involve charging a capacitor by power received from the distributed power wire. The method may involve: (a) determining a number of available recipients operable to receive the measurement result from the measurement acquisition unit via wireless communication; (b) if there are one or more the available recipients, selecting a recipient from among the one or more available recipients; and (c) if there are no the available recipients, storing in a memory of the measurement acquisition unit the measurement result and a measurement count in association therewith. If there are one or more the available recipients, selecting a recipient from among the one or more available recipients may involve selecting the recipient such that the number of transmissions required to communicate the measurement result from the measurement acquisition unit to a monitoring center is minimized. Selecting the recipient such that the number of transmissions required to communicate the measurement result to a monitoring center is minimized may involve, if a plurality of the available recipients have associated therewith a same minimal number of transmissions required to communicate the measurement result from the measurement acquisition unit to the monitoring center, selecting the recipient such that signal strength of communications between the recipient and the measurement acquisition unit is maximized. The method may involve transmitting by the measurement acquisition unit to the recipient via wireless communication the measurement result and any previously stored measurement results and associated measurement counts not previously transmitted by the measurement acquisition unit. The method may involve receiving by a second measurement acquisition unit the measurement result, and transmitting by the second measurement acquisition to a monitoring center via wired communication the measurement result. The method may involve setting, in response to the measurement result, an amount of time to elapse before producing a subsequent measurement result.

In accordance with another aspect of the invention, there is provided a measurement sensor for detecting moisture. The measurement sensor includes: (a) a pair of spaced apart conductors; and (b) an impedance circuit electrically connectable in parallel with the pair of conductors and having a finite impedance such that when the impedance circuit is connected an impedance of the measurement sensor greater than the finite impedance indicates an impaired connection.

The impedance circuit may connected to the pair of conductors proximate to a connection end of the measurement sensor. The impedance circuit may be connected to the pair of conductors proximate to a terminal end of the measurement sensor. The impedance circuit may include a thermistor such that the impedance of the impedance circuit varies with temperature. The impedance circuit may include a diode such that the impedance of the impedance circuit varies with the polarity of a voltage applied to the measurement sensor. The impedance circuit may include at least one sub-circuit electrically connectable in parallel with the pair of conductors, the at least one sub-circuit comprising at least one diode in series with at least one other electrical component. The at least one sub-circuit may include first and second sub-circuits, the first sub-circuit comprising a first diode disposed in a first direction, the second sub-circuit comprising a second diode disposed in a second direction opposite the first direction. The measurement sensor may include a non-hydrophobic material attached to the pair of spaced conductors. The measurement sensor may have a first diode connected to the pair of conductors in a first direction at a connection end of the pair of conductors. The measurement sensor may include a second pair of spaced apart conductors. The measurement sensor may include a second diode connected to the second pair of conductors in a second direction at a second connection end of the second pair of connectors. The measurement sensor may include a second impedance circuit connected to the second pair of conductors proximate to a second terminal end of the second pair of conductors. The second impedance circuit having a second finite impedance such that an impedance of the measurement sensor that is determined in accordance with the second direction to be greater than the second finite impedance indicates an impaired connection.

In accordance with another aspect of the invention, there is provided a termination module for a moisture detection measurement sensor, the sensor comprising a pair of spaced apart conductors. The termination module includes: (a) a base attachable to the sensor; and (b) an impedance circuit supported by the base such that the impedance circuit is electrically connected in parallel with the pair of conductors when the base is attached to the sensor, the impedance circuit having a finite impedance such that when the base is attached to the sensor an impedance of the measurement sensor greater than the finite impedance indicates an impaired connection.

The base may include a printed circuit board dimensioned to receive a pair of probes, the impedance circuit being electrically connected between the pair of probes when the pair of probes is being received by the printed circuit board. The termination module may include a temperature sensor supported by the base. The impedance circuit may include a diode such that the impedance of the impedance circuit varies with the polarity of a voltage applied to the impedance circuit. The impedance circuit may include first and second sub-circuits, the first sub-circuit comprising a first diode disposed in a first direction in series with at least one other electrical component, the second sub-circuit comprising a second diode disposed in a second direction opposite the first direction.

In accordance with another aspect of the invention, there is provided a moisture content measurement sensor for measuring moisture content of a structural material. The moisture content measurement sensor includes: (a) a pair of spaced apart conductors enclosed within an electrically insulating material; and (b) a plurality of electrically conductive probe supports, each of the probe supports being attached to one of the conductors and dimensioned to receive a probe for insertion into the structural material, each of the probe supports forming an electrical connection between the one conductor and the probe.

Each of the probe supports may include an eyelet rivet. The moisture content measurement sensor may include an impedance circuit electrically connectable in parallel with the pair of conductors and having a finite impedance such that when the impedance circuit is connected an impedance of the measurement sensor greater than the finite impedance indicates an impaired connection. The plurality of electrically conductive probe supports may include at least one pair of the probe supports, the at least one pair being dimensioned to receive a termination module comprising a base and an impedance circuit supported by the base such that the impedance circuit is electrically connected in parallel with the at least one pair when the termination module is received by the at least one pair, the impedance circuit having a finite impedance such that when the termination module is received by the at least one pair an impedance of the moisture content measurement sensor greater than the finite impedance of the impedance circuit alone indicates an impaired connection.

In accordance with another aspect of the invention, there is provided a measurement sensor for monitoring a structure. The measurement sensor includes: (a) measurement sensing means for measuring a feature of the structure; and (b) connection test means for indicating an impaired connection of the measurement sensor, the connection test means being electrically connectable in parallel with the measurement sensing means and having a finite impedance such that when said connection test means is connected an impedance of the measurement sensor greater than the finite impedance indicates the impaired connection.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective view of a building installation of a system for monitoring a structure according to a first embodiment of the invention;

FIG. 2 is a block diagram of a data acquisition unit of the system shown in FIG. 1, showing a sensor circuit controlled by a processor;

FIG. 3 is a schematic representation of sensor circuitry of the data acquisition unit shown in FIG. 2, showing first and second reference resistors;

FIG. 4 is a flow diagram of a method of the system shown in FIG. 1 of monitoring a structure in accordance with the first embodiment of the invention;

FIG. 5 is a flow diagram of an exemplary method of performing the step shown in FIG. 4 of determining an operating mode of the data acquisition unit shown in FIG. 2;

FIG. 6 is a flow diagram of an exemplary method of performing the step shown in FIG. 4 of providing a measurement result in accordance with the operating mode;

FIG. 7 is a flow diagram of an exemplary method of performing the step shown in FIG. 6 of producing the measurement result in wired mode, showing the step of electrically isolating from a bus;

FIG. 8 is a flow diagram of an exemplary method of performing the step shown in FIG. 6 of updating a profile of the data acquisition unit shown in FIG. 2;

FIG. 9 is a flow diagram of an exemplary method of performing the step shown in FIG. 6 of producing the measurement result in wireless mode, showing the step of electrically isolating from a power conduit;

FIG. 10 is a flow diagram of an exemplary method of performing the step shown in FIG. 6 of transmitting the measurement result to a preferred recipient, showing steps for selecting the preferred recipient;

FIG. 11 is a flow diagram of an exemplary method of performing the step shown in FIG. 6 of setting a power state of the data acquisition unit shown in FIG. 2, showing reconfiguring pins for low leakage;

FIG. 12 is a flow diagram of a method of the system shown in FIG. 1 of responding to a communication received from the data acquisition unit shown in FIG. 2;

FIG. 13 is a top view of a prior art leak detection tape, showing a pair of spaced apart conductors and a substrate;

FIG. 14 is a sectional view along lines 14-14 of the prior art leak detection tape shown in FIG. 13, showing an adhesive layer;

FIG. 15 is an end view of an encloseable moisture content sensor suitable for use with the system shown in FIG. 1, showing two spaced apart adhesive layers;

FIG. 16 is a top view of a moisture content sensor suitable for use with the system shown in FIG. 1, showing an enclosure made of an electrically insulating material;

FIG. 17 is a sectional view along lines 17-17 of the moisture content sensor shown in FIG. 16, showing an eyelet rivet in cross-section;

FIG. 18a is a top view of a measurement sensor suitable for use with the system shown in FIG. 1, showing a schematic representation of an impedance circuit comprising a reference impedance;

FIG. 18b is a top view of the measurement sensor shown in FIG. 18a, showing a schematic representation of the impedance circuit comprising a thermistor;

FIG. 18c is a top view of the measurement sensor shown in FIG. 18a, showing a schematic representation of the impedance circuit comprising a diode;

FIG. 18d is a top view of the measurement sensor shown in FIG. 18a, showing a schematic representation of the impedance circuit comprising a dual reference impedance circuit;

FIG. 18e is a top view of the measurement sensor shown in FIG. 18a, showing two pairs of conductors and a diode arrangement for selection therebetween;

FIG. 19a is a top view of a termination module suitable for use with the system shown in FIG. 1, showing a printed circuit board (PCB);

FIG. 19b is a top view of the termination module shown in FIG. 19a, showing the termination module attached to a leak detection and moisture content measurement sensor at its termination end;

FIG. 20a is a top view of a variation of the termination module shown in FIG. 19a, showing a cable housing; and

FIG. 20b is a top view of the termination module shown in FIG. 20a, showing the termination module attached to a condensation sensor at its connection end.

### DETAILED DESCRIPTION

A system for monitoring a structure includes: (a) measurement acquisition means for producing measurement results, the measurement acquisition means including first connection means for receiving a sensor unit electrically connected to the structure, the measurement acquisition means including second connection means for receiving an electrical connection to the structure; and (b) isolation means for electrically isolating the second connection means from the first connection means when invoking the sensor unit so as to produce the measurement results. The measurement acquisition means may include wired communication means for communicating the measurement results via wired transmission. The measurement acquisition means may include wireless communication means for communicating the measurement results via wireless transmission. The measurement acquisition means may include internal powering means for powering the measurement acquisition means when invoking the sensor unit.

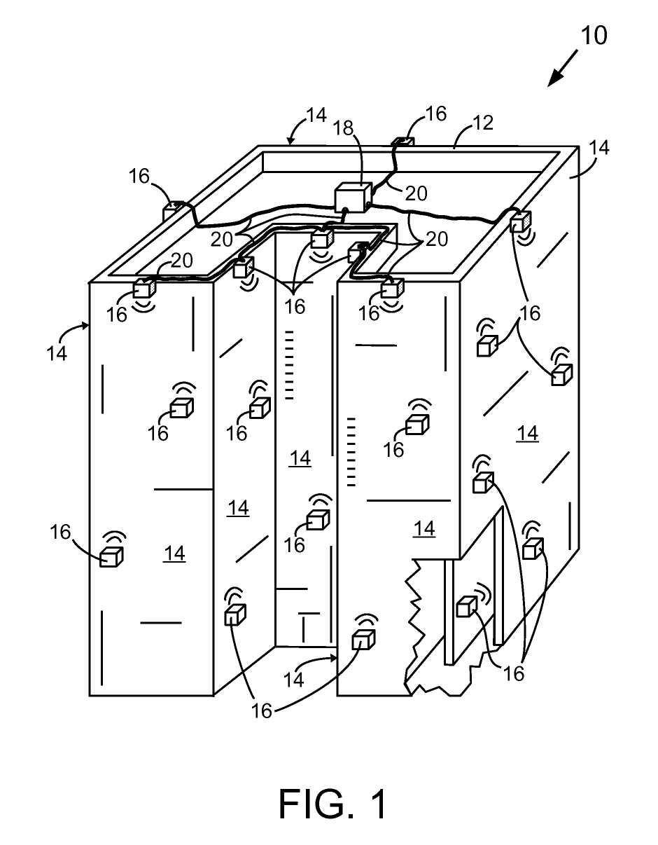

Referring to FIG. 1, the system according to a first and preferred embodiment of the invention is shown generally at 10. The system 10 is operable to monitor a structure such as the building 12 shown in FIG. 1. The system is operable to monitor the building 12 by measuring moisture, condensation, leaks, humidity, temperature, heat flux, pressure, air quality, presence of gases, presence of volatile chemicals, and other physical features of the building 12. The terms measure, measurement and grammatical variations thereof are used herein to refer to any form of sensing, quantifying, representing or detecting any physical phenomena related to any form of structure, structural material or the environment of or within a structure or structural material.

The building 12 may have any structural size and shape with one or more faces such as the walls 14 shown in FIG. 1. While FIG. 1 shows the building 12 having the exemplary vertically planar exterior walls 14, the faces of the building 12 may have any contour and have any slope at any point thereof. A face of a structure may be a sloped and curved rooftop and/or roof membrane (not shown), for example.

The system 10 includes any number of measurement acquisition units such as the data acquisition units 16 mounted on, installed in or otherwise located in proximity to the building 12. Each data acquisition unit 16 is operable to cause measurements for monitoring the building 12 to be performed. Preferably, at least one data acquisition unit 16 is operable to provide measurement results of such measurements to a monitoring center such as the gateway 18 shown in FIG. 1. The system 10 may include any number of gateways 18. Each gateway 18 is typically mounted on or installed in the building 12. However, any given gateway 18 may be mounted or installed at any location within wired or wireless communication range of one or more data acquisition units 16.

The gateway 18 may, for example, be any computing device such as a general purpose computer, microcomputer, minicomputer, mainframe computer, distributed network for computing, functionally equivalent discrete hardware components, etc. and any combination thereof.

In the first embodiment, the gateway 18 can receive data, such as digital data representing a measurement result, from at least one of the data acquisition units 16. As shown in FIG. 1, the data may be received by wired communication, wireless communication or any combination thereof by any communication network arrangement between the gateway 18 and the data acquisition units 16.

The gateway 18 in at least some embodiments can process data received from a data acquisition unit for monitoring the building 12. Such data processing might include for example communicating the data to a central monitoring center (not shown) by any industry standard or proprietary communications technique including by Internet or other network connection (not shown); uploading data for inclusion in a webpage of a website; storing data in a database (not shown) for later retrieval; data analysis such as to produce monitoring status, statistics or information related to the building 12; triggering an event such as an alarm event in response to the received data; communicating an event to personnel or a processor by e-mail, SMS (Short Message Service) message, pager message, graphic display, visual indicator, audible indicator, tactile indicator such as a vibration, initiation of a mechanical force such as activation of an electromechanical relay, and any combination thereof; communicating event-related information to one or more data acquisition units 16, such as communicating an alarm to a data acquisition unit 16 in response to data received from that data acquisition unit 16; activating an actuator such as by relay activation; and any combination thereof.

The gateway 18 in the first embodiment is operable to communicate with at least one data acquisition unit 16 by a wired connection such as the CAN (Control Area Network) bus 20 shown in FIG. 1. In the exemplary embodiment shown in FIG. 1, the CAN bus 20 extends between the gateway 18 and eight data acquisition units 16 located along the periphery of the top of the building 12. In general, the CAN bus 20 may include any number of separate or connected wired connections and may form or include a star, tree, cluster, ring or any other wired network arrangement, for example. In the system 10, at least one data acquisition unit 16 is preferably operable to communicate directly with the gateway 18, which in the first embodiment includes communicating directly with the gateway 18 via the CAN bus 20.

Communication between data acquisition units 16 may occur by any suitable technique, including by wireless and/or wired communication. In the exemplary embodiment shown in FIG. 1, twelve data acquisition units 16 not directly connected to the CAN bus 20 are visible, including eleven data acquisition units 16 located adjacent an exterior wall 14 and one data acquisition unit 16 located within the interior of the building 12 and made visible by the cut-out of FIG. 1. In the first embodiment, each data acquisition unit 16 is operable to communicate with a specifiable other data acquisition unit 16 by wireless communications. In the exemplary embodiment shown in FIG. 1, the wired and wireless data acquisition units 16 form a wired/wireless hybrid network with a tree cluster type network arrangement. Along a given wall 14, a number of data acquisition units 16 not connected to the CAN bus 20 are operable to cause measurements to be performed and to communicate measurement results by wireless communications to a data acquisition unit 16 connected to the CAN bus 20 and located near the top of the given wall 14. The data acquisition unit 16 connected to the CAN bus 20 is then operable to transmit measurement results received from other data acquisition units 16 to the gateway 20 via wired communications along the CAN bus 20. Furthermore, any number of data acquisition units 16 may be located within the interior of the building 12 and operable to communicate measurement results to a data acquisition unit 16 located at the exterior of the building 12 such as for retransmission to a data acquisition unit 16 connected to the CAN bus 20.

The number of transmissions required to deliver a communication from a given data acquisition unit 16 to a data acquisition unit 16 in wired communication with the gateway 18 may be referred to as the hop count for that given data acquisition unit 16. For example, the data acquisition units 16 connected to the CAN bus 20 each have hop counts of zero. Data acquisition units have a hop count of one if operable to communicate with a CAN bus 20 connected data acquisition unit 16. Other hop count values are possible.

Locating at least one data acquisition unit 16 at a given wall 14 for receiving measurement results from a number of other data acquisition units 16 also located at the given wall 14 advantageously permits line-of-sight wireless communication between the at least one data acquisition unit 16 and the other data acquisition units 16. As shown in the exemplary embodiment of FIG. 1, the wall 14 has a generally flat exterior surface, thereby permitting visual line-of-sight communication between the at least one data acquisition unit 16 and the the other data acquisition units 16. However, in general the wall 14 may have any contour, and the line-of-sight wireless communication need not be limited to visual line-of-sight communication. The system 10 is operable to advantageously make use of the wall 14, having any countour, as a ground plane for wireless communications, thereby improving the signal-to-noise ratio of such communications.

Any communication between data acquisition units 16, between a data acquisition unit 16 and the gateway 18, and/or with the central monitoring center (not shown) may be transmitted in accordance with any communications protocol, including employing encryption or other techniques for enhancing security of communications. Any communication of the system 10 may involve transmission at any frequency, frequencies or ranges thereof, including using an available 900 MHz and/or 2.4 GHz frequency band.

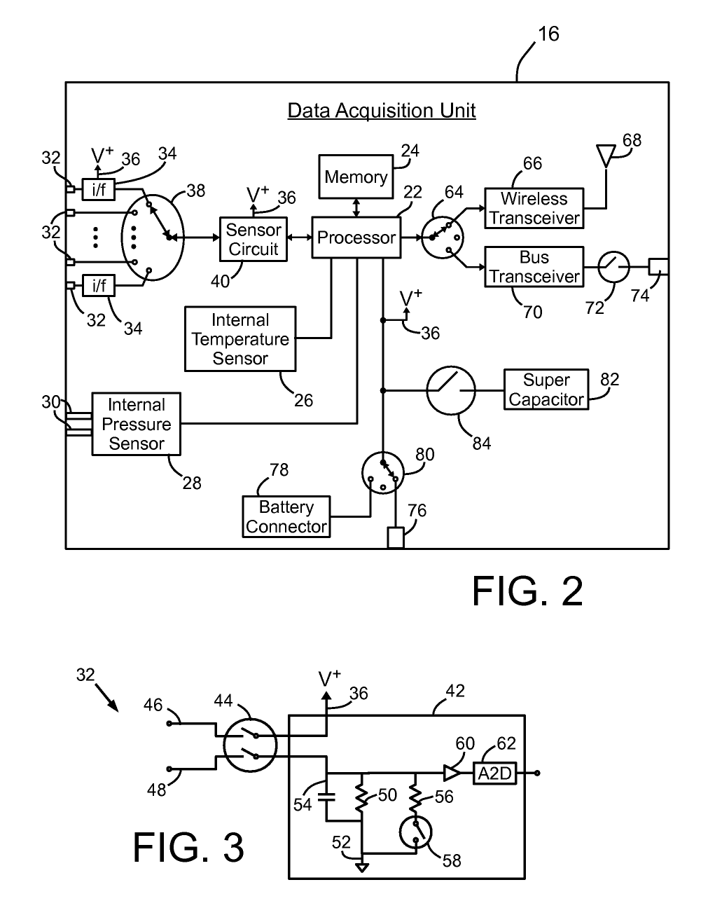

Referring to FIG. 2, the data acquisition unit 16 in the first embodiment includes a processing circuit, such as the processor 22, and a memory circuit such as the memory 24.

The processor 22 is typically a processing circuit that includes one or more circuit units, such as a central processing unit (CPU), digital signal processor (DSP), embedded processor, etc., and any combination thereof operating independently or in parallel, including possibly operating redundantly. The processor 22 may be implemented by one or more integrated circuits (IC), including being implemented by a monolithic integrated circuit (MIC), an Application Specific Integrated Circuit (ASIC), a Field Programmable Gate Array (FPGA), etc. or any combination thereof. Additionally or alternatively, the processor 22 may be implemented as a programmable logic controller (PLC), for example. The processor 22 may include circuitry for storing memory, such as digital data, and may comprise the memory 24 or be in wired communication with the memory 24, for example. In the first embodiment, the processor 22 includes, or is otherwise in communication with, timing circuitry for implementing a timer.

The memory 24 in the first embodiment is operable to store digital representations of data or other information, including measurement results, and to store digital representations of program data or other information, including program code for directing operations of the processor 22.

Typically, the memory 24 is all or part of a digital electronic integrated circuit or formed from a plurality of digital electronic integrated circuits. The memory 24 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory 24 may be operable to store digital representations as volatile memory, non-volatile memory, dynamic memory, etc. or any combination thereof.

In at least some embodiments, the data acquisition unit 16 includes an internal temperature sensor 26 for sensing the temperature at the data acquisition unit 16. In such embodiments, the data acquisition unit 16 can invoke the internal temperature sensor 26 so as to produce the internal temperature of the data acquisition unit 16, and can communicate that temperature to the gateway 18 as an indication of an ambient temperature of the building 12 at the location of that data acquisition unit 16.

In at least some embodiments, the data acquisition unit 16 includes an internal pressure sensor 28 for sensing pressure, such as differential pressure at terminal ends of a pair of pressure tubes (not shown) connected externally to the data acquisition unit 16 at the pressure tube connectors 30. In such embodiments, the data acquisition unit 16 can invoke the internal pressure sensor 28 so as to produce a differential pressure measurement result to facilitate monitoring the building 12.

In the first embodiment, the data acquisition unit 16 includes a plurality of measurement sensor connectors 32 for connecting to external measurement sensor units (not shown in FIG. 2). Such measurement sensor units may be of any type and function to perform measurements of any kind, including for example sensing, quantifying, detecting or otherwise measuring moisture, condensation, leaks, humidity, temperature, heat flux, pressure, air quality, presence of gases, presence of volatile chemicals, and other physical features of, within or surrounding structures or structural materials thereof.

In the exemplary embodiment of FIG. 2, two measurement sensor connectors 32 are shown connected to an interface circuit 34, and one of the exemplary interface circuits includes a power supply voltage connection 36. In general, each measurement sensor connector 32 may be connected to interface circuits 34 that are identical, or different measurement sensor connectors 32 may be connected to different interface circuits 34 for optimal use with different measurement sensor units (not shown in FIG. 2) or different types of measurement sensor units. Each interface circuit 34 may include electronic conditioning circuitry for interfacing with one or more measurement sensor units or one or more types of measurement sensor units.

Whether through an interface circuit 34 or not, in various embodiments the measurement sensor connectors 32 are connected to a measurement sensor selector such as the measurement sensor switch 38 for separately connecting one measurement sensor connector 32 to an electronic circuit such as the sensor circuit 40 shown in FIG. 2. The sensor circuit 40 can be any electronic circuit connected between the measurement sensor switch 38 and the processor 22.

In the first embodiment, the sensor circuit 40 includes sensor driver circuitry for receiving a measurement result produced by a measurement sensor unit connected externally to a given measurement sensor connector 32. The interface circuit 34, the sensor circuit 40, both or neither may include in various embodiments analog conditioning circuitry such as circuitry for amplification, including automatic gain control amplification and/or gain range selectable amplification, buffering, circuitry for filtering, including low-pass filtering to reduce noise, or other suitable electronic circuitry.

In the first embodiment, the sensor circuit 40 includes an analog-to-digital converter for converting analog measurement results, obtained by invoking the measurement sensor unit, to digital measurement results, which can be readily received as input by the processor 22. In some embodiments, the data acquisition unit 16 includes a plurality of analog-to-digital converters, including having different analog-to-digital converters operable to perform analog-to-digital conversion at different precision levels. The data acquisition unit 16 may include one high-precision analog-to-digital converter and one standard- or low-precision analog-to-digital converter, for example. The sensor circuit 40 need not include a power supply voltage connection 36 in all embodiments. Power provided via the power supply voltage connection 36 may be of any suitable type, including being provided by a low drift voltage reference output.

The interface circuit 34, the measurement sensor switch 38 and the sensor circuit 40 may each be implemented by electronic circuitry internal to the processor 22, external to the processor 22, or any combination thereof. While for simplicity of illustration FIG. 2 shows one set of measurement sensor connectors 32, two interface circuits 34, one measurement sensor switch 38 and one sensor circuit 40, the data acquisition unit 16 may include any number of sets of measurement sensor connectors 32, any number of interface circuits 34, any number of measurement sensor switches 38, any number of sensor circuits 40, and any combination thereof including bypassing the measurement sensor switch 38 in respect of one or more measurement sensor connectors 32 for example.

Referring to FIG. 3, exemplary circuitry for implementing the sensor circuit 40 in accordance with some embodiments is shown generally at 42. The sensor circuitry 42 includes one power supply voltage connection 36, which is connected to one switching portion 44 of the measurement sensor switch 38 operable to connect and disconnect the one measurement sensor connector 32 shown in FIG. 3. When the switching portion 44 is closed, such as by being closed under the control of the processor 22, electrical power, provided by the power supply voltage connection 36, is connected to one terminal 46 of the switching portion 44 so as to apply a voltage to any measurement sensor unit (not shown in FIG. 3) connected externally to the measurement sensor connector 32. The other terminal 48 of the measurement sensor connector 32 is also connected to the switching portion 44. When the switching portion 44 is closed, the other terminal 48 connects to the sensor circuitry 42 such that the sensor circuitry 42 is operable to receive a measurement result produced by the connected measurement sensor unit. The switching portion 44 preferably provides a low loss connection between the measurement sensor unit and the sensor circuitry 42.

For receiving measurement results, the sensor circuitry 42 includes a reference resistor 50 connected between the switching portion 44 output and an analog ground 52 of the sensor circuitry 42, as shown in FIG. 3. The reference resistor 50 may be a high precision reference resistor having a resistance value of typically 1 Mega-ohms and a resistance precision of 1%, 0.1% or 0.01% for example. In some embodiments including that shown in FIG. 3, a shunt capacitor 54, connected in parallel with the reference resistor 50, advantageously reduces high frequency noise so as to enhance measurement accuracy of the data acquisition unit 16. In some embodiments, the shunt capacitor 54 has a capacitance value of up to 50 nF, including having a capacitance value of 470 pF. However, the shunt capacitor 54 need not be used in all embodiments and may be omitted from at least some embodiments. The sensor circuitry 42 also includes a second reference resistor 56 connected in series with a reference switch 58. The second reference resistor 56 typically has a lower resistance value than the reference resistor 50, such as a resistance value of 100 kohms for example. The second reference resistor 56 may have any resistance precision including 1%, 0.1% and 0.01% for example. The reference switch 58 is typically under the control of the processor 22 and can connect and disconnect the second reference resistor 56 between the switching portion 44 output and the analog ground 52. The reference switch 58 advantageously permits the data acquisition unit 16 to select the shunt resistance between the switching portion 44 output and the analog ground 52. Closing the reference switch 58 advantageously decreases a settling time of the measurement circuitry after closing the switching portion 44. In some embodiments, the processor 22 is operable to close the switching portion 44 and the reference switch 58, wait the reduced settling time, open the reference switch 58 and proceed with receiving a measurement result using the voltage divider created by the measurement sensor unit and the reference resistor 50. In some embodiments, the processor 22 also waits a second settling time after the reference switch has been opened and before receiving the measurement result. Additionally or alternatively, the processor 22 may be operable to receive a measurement result while both the switching portion 44 and the reference switch 58 are closed. As shown in FIG. 3, the sensor circuitry 42 includes a buffer amplifier 60, which preferably has a low leakage current high impedance input for improved measurement accuracy. The buffer amplifier 60 output connects to the input of an analog-to-digital converter 62 for converting the analog measurement result received by the sensor circuitry 42 to digital representations thereof. In some embodiments, the output of the analog-to-digital converter 62 is connected to an input of the processor 22. Additionally or alternatively, the buffer amplifier 60, the analog-to-digital converter 62, or both the buffer amplifier 60 and the analog-to-digital converter 62 may form part of the processor 22.

Referring back to FIG. 2, an output of the processor 22 is connected to an input of the sensor circuit 40, and an output of the sensor circuit 40 is connected to an input of the processor 22. The processor 22 can invoke a measurement sensor unit through the sensor circuit 40 or portion thereof, measurement sensor switch 38, any interface circuit 34 present and a selected measurement sensor connector 32 to produce a measurement result received by the processor 22 from the selected measurement sensor connector 32 via any one or more of the interface circuit 34, the measurement sensor switch 38 and the sensor circuit 40.

In the first embodiment shown in FIG. 2, the processor 22 is operable to store received measurement results in the memory 24, including storing on a temporary basis as volatile memory data and/or storing for long term data storage as non-volatile memory data.

In the first embodiment shown in FIG. 2, the data acquisition unit 16 includes a measurement result selector, such as the measurement result switch 64 shown in FIG. 2, connected to receive a measurement result output of the processor 22. In the first embodiment, the measurement result switch 64 is operable to provide such measurement result to a wireless transceiver 66 having a transceiver antenna 68 for communicating the measurement result via wireless transmission, to a bus transceiver 70 for communicating the measurement result via wired transmission, or to neither the wireless transceiver 66 nor the bus transceiver 70 in which case a remainder section of the data acquisition unit 16, including the processor 22 and the measurement sensing circuitry of the data acquisition unit 16, are electrically isolated from the bus transceiver 70. Typically, the measurement result switch 64 is under the control of the processor 22, which directs the measurement result switch 64 to select a specified output of the measurement result switch 64 for a specifiable duration, including possibly until further directed to change its selection. While the measurement result switch 64 is shown in FIG. 2 as having three selectable outputs, in some embodiments only two selectable outputs are used to permit a selection between the wireless transceiver 66 and the bus transceiver 70 such that when the wireless transceiver 66 is selected the remainder section of the data acquisition unit 16 is electrically isolated from the bus transceiver 70.

The wireless transceiver 66 in the first embodiment is operable to communicate via wireless transmission with other devices capable of wireless communications. Such other devices may include another data acquisition unit 16, the gateway 18, any device operable to communicate by wireless transmission in accordance with a wireless communication protocol that is compatible with that of the wireless transceiver 66, and any other suitable device for example. The system 10 is operable in various embodiments to effect communications by any suitable wireless connection, including a radio link, a cellular telephone link, a satellite link, a line-of-sight link, including a line-of-sight radio link and/or a line-of-sight free optical link, and any combination thereof for example.

In at least some embodiments, the transceiver antenna 68 is advantageously directional such that line-of-sight wireless communication between data acquisition units adjacent a given wall 14 (FIG. 1) can be facilitated by directing the respective transceiver antennas 68 accordingly. For example, a data acquisition unit 16 connected to the CAN bus 20 and located near the top of a given wall 14 (FIG. 1) may have its transceiver antenna 68 directed in a generally downward direction along the given wall 14 for receiving communications from other data acquisition units 16 located at the given wall 14, while such other data acquisition units 16 may have their respective transceiver antennas 68 directed in a generally upward or otherwise toward the data acquisition unit 16 connected to the CAN bus 20. A person of ordinary skill in the art will appreciate that an innumerable variety of arrangements forming a variety of network architectures, including a cluster tree type network architecture, are possible. The illustrated arrangement of FIG. 1 is exemplary only.

The bus transceiver 70 in the first embodiment of FIG. 2 is operable to communicate by wired transmission with other devices capable of wired communications. Such other devices may include the gateway 18, another data acquisition unit 16, any device operable to communicate by wired transmission in accordance with a wired communication protocol that is compatible with that of the bus transceiver 70, and any other suitable device for example. The system 10 is operable in various embodiments to effect communications by any suitable wired connection, including a copper wire link, a coaxial cable link, stripline or other printed circuit trace link, a waveguide link, a fiber-optic transmission link, and any combination thereof for example.

As shown in FIG. 2, the bus transceiver 70 is connected at its output to a bus switch 72, which is connected between the bus transceiver 70 and a bus connector 74. The bus switch 72 can disconnect and electrically isolate the bus connector 74 from the remainder of the data acquisition unit 16 including the bus transceiver 70. Typically, the operation of the bus switch 72 is under the control of the processor 22 such that the bus switch 72 opens and closes in response to commands produced by the processor 22.

The bus connector 74 in the first embodiment is dimensioned to receive a wired communications bus such as the CAN bus 20 (FIG. 1). Additionally or alternatively, the bus connector 74 may be compatible with other physical wired communications buses (not shown).

For comprehensive exemplary illustration, both the measurement result switch 64 and the bus switch 72 are shown in FIG. 2 as being operable to electrically disconnect the bus connector 74 from other parts of the data acquisition unit 16. However, it is not necessary for all embodiments to include both such operabilities and, in various embodiments, the bus switch 72 or the ability of the measurement result switch 64 to electrically isolate the remainder section of the data acquisition unit 16 from the bus transceiver 70 is omitted.

In accordance with the first embodiment shown in FIG. 2, the data acquisition unit 16 is operable to function in a distributed power mode in which the data acquisition unit 16 is powered via a connection to an external power source and/or a stand-alone power mode in which the data acquisition unit 16 is self-powered by a stand-alone power source.

As shown in FIG. 2, the first embodiment includes a distributed power connector 76 for receiving power from an external power source (not shown) such as a distributed power source (not shown). Such distributed power source may be operable to provide power to any number of data acquisition units 16, for example, and may be of any power supply type. The distributed power connector 76 is preferably dimensioned for receiving a power conduit (not shown) suitable for providing electrical power of the external power source. The data acquisition unit 16 is in some embodiments operable to receive DC (Direct Current) power, typically at a substantially constant voltage such as +5 volts, via the distributed power connector 76. Additionally or alternatively, the data acquisition unit 16 may be operable to receive AC (Alternating Current) power, typically at a substantially constant alternating frequency and within a specifiable voltage range, via the distributed power connector 76. In at least some embodiments where AC power is received, the data acquisition unit 16 includes power supply circuitry operable to convert the AC power to DC power for use by components of the data acquisition unit 16.

In the first embodiment, the data acquisition unit 16 includes a stand-alone power connector, such as the battery connector 78, for receiving power from a stand-alone power source such as a battery (not shown) for supplying power to the data acquisition unit 16. Typically, the battery connector 78 permits the data acquisition unit 16 to receive DC power. In various embodiments, the battery connector 78 is not limited to receiving power from a battery, but may be dimensioned for receiving power from any suitable type of stand-alone power source, including a stand-alone electrical generator, solar panel unit, wind turbine unit, or any combination thereof for example. In some embodiments, the data acquisition unit 16 is operable to be powered by vibration sensing means and/or by induced voltages.

The data acquisition unit 16 in the first embodiment includes a selector, such as the power mode switch 80, for selecting between receiving power through the distributed power connector 76, receiving power through the battery connector 78, and neither receiving power through the distributed power connector 76 nor through the battery connector 78 such that a remaining portion of the data acquisition unit 16 is electrically isolated from the distributed power connector 76. While the power mode switch 80 is shown in FIG. 2 as having three selectable outputs, in some embodiments only two selectable outputs are used to permit a selection between the distributed power connector 76 and the battery connector 78 such that when the battery connector 78 is selected the remaining portion of the data acquisition unit 16 is electrically isolated from the distributed power connector 76.

The first embodiment preferably includes an auxiliary power source, such as the super capacitor 82 shown in FIG. 2, for powering the data acquisition unit 16 while the remaining portion of the data acquisition unit 16 is electrically isolated from the distributed power connector 76 and/or the battery connector 78. While the exemplary embodiment of FIG. 2 shows the auxiliary power source implemented as a super capacitor 82, any power source electrically isolated from the building 12 may suitably be employed, including any capacitor, battery, electrical generator, renewable energy source such as a solar panel unit or wind turbine unit, etc., and any combination thereof for example.

The auxiliary power switch 84 of the first embodiment is operable to connect, and disconnect, the super capacitor 82 to, and from, other components of the data acquisition unit 16. The data acquisition unit 16 is advantageously operable in the first embodiment to select between receiving power from the super capacitor 82, through the distributed power connector 76 or through the battery connector 78. The data acquisition unit 16 is furthermore operable in the first embodiment to form a connection between the super capacitor 82 and power received either through the distributed power connector 76 or the battery connector 78, thereby permitting the super capacitor 82 to be charged up. The super capacitor 82 is operable to discharge by supplying power to the data acquisition unit 16, for example.

As is well known in the art, at least some measurement sensor units include electrical connections to a structure being sensed by the measurement sensor unit. For example, such measurement sensor units may include probes inserted into the structure or a material thereof. By way of further example, structural fasteners inserted into the structure during construction, maintenance, renovation or repair of the structure may be inadvertently inserted through at least a portion of a measurement sensor unit, thereby creating an electrical connection to the structure.

The data acquisition unit 16 in the first embodiment is advantageously operable to invoke a given measurement sensor unit while being electrically connected to the building 12 only through that measurement sensor unit. In the first embodiment, accomplishing such single electrical connection to the building 12 involves electrically isolating portions of the data acquisition unit 16, including the processor 22 and the measurement sensor connection 32 connected to the given measurement sensor unit, from one or more of the bus connector 74, bus transceiver 70, wireless transceiver 66, distributed power connector 76 and the battery connector 78. Such electrical isolation advantageously avoids electrical ground loops, which might otherwise adversely affect the accuracy and/or precision of measurement results produced by the system 10. Such electrical isolation advantageously permits the system 10 to permit measurements to be performed simultaneously by multiple data acquisition units 16, including multiple data acquisition units 16 installed at the same building 12, thereby enhancing efficiencies in producing measurement results.

Thus, there is provided a system for monitoring a structure, the system comprising a measurement acquisition unit having first and second connection points, said measurement acquisition unit being operable to receive at said first connection point a sensor unit electrically connected to the structure, said measurement acquisition unit being operable to receive at said second connection point an electrical connection to the structure, said measurement acquisition unit being operable to electrically isolate said second connection point from said first connection point when invoking said sensor unit so as to produce a measurement result for monitoring the structure.

In accordance with another aspect of the invention, there is thus provided an apparatus for producing a measurement result to facilitate monitoring a structure, the apparatus comprising: (a) a first connector for receiving a sensor unit electrically connected to the structure; (b) a second connector for receiving an electrical connection to the structure; and (c) a switch for electrically isolating said second connector from said first connector when invoking said sensor unit so as to produce the measurement result.

### Method of Operation

Referring to FIG. 2, the memory 24 of a given data acquisition unit 16 in accordance with the first embodiment of the invention contains blocks of code comprising computer executable instructions for directing the processor 22. Additionally or alternatively, such blocks of code may form part of a computer program product comprising computer executable instructions embodied in a signal bearing medium, which may be a recordable computer readable medium or a signal transmission type medium, for example.

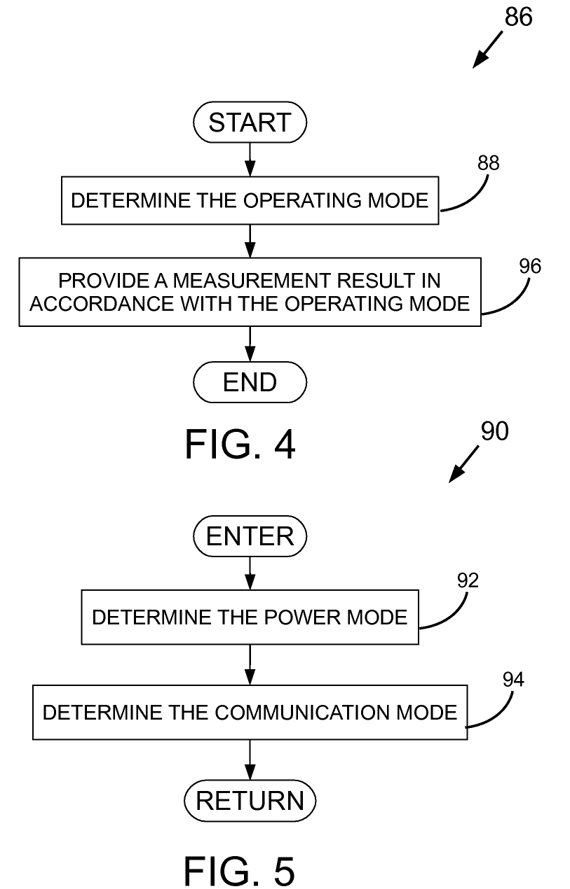

Referring to FIG. 4, when electrical power is being supplied to the processor 22 (FIG. 2) and the memory 24 (FIG. 2), the processor 22 is directed to perform the steps of a method shown generally at 86. Method 86 begins at block 88, which directs the processor 22 to determine the operating mode of the given data acquisition unit 16.

Referring to FIG. 5, an exemplary method for performing steps of block 88 is shown generally at 90. Method 90 begins at block 92, which directs the processor 22 to determine a power mode of the data acquisition unit 16. For example, the power mode may be the distributed power mode in which the data acquisition unit 16 is powered by an external power source via the distributed power connector 76 (FIG. 2), or the stand-alone power mode in which the data acquisition unit 16 is self-powered by a stand-alone power source via the battery connector 78 (FIG. 2). The power mode may be determined by determining whether a power conduit is connected to the distributed power connector 76, whether a stand-alone power source is connected to the battery connector 76, whether a power supply voltage is present at the distributed power connector 76, whether a power supply voltage is present at the battery connector 78, whether a power supply current is flowing through the distributed power connector 76, whether a power supply current is flowing through the battery connector 78, or any combination thereof. In at least some embodiments, executing block 92 includes creating, updating or otherwise storing a power mode indicator for subsequent use or retrieval. When block 92 has been executed, the processor 22 is directed to execute block 94.

Block 94 directs the processor 22 to determine a communication mode of the data acquisition unit 16. For example, the communication mode may be a wired communications mode or a wireless communications mode. In the wired communication mode in accordance with the first embodiment, a wired connection such as the CAN bus 20 (FIG. 2) is received by the data acquisition unit 16 for effecting wired communications via the bus transceiver 70 (FIG. 2). In the wireless communications mode in accordance with the first embodiment, communications are effected via the wireless transceiver 66 (FIG. 2). The communications mode may be determined by determining whether a wired connection is connected to the bus connector 74, for example. In the first embodiment, the communication mode of the data acquisition unit 16 is the wired communications mode unless no wired connection is available for wired communications, however, other arrangements are possible. In at least some embodiments, executing block 94 includes creating, updating or otherwise storing a communication mode indicator for subsequent use or retrieval.

After block 94 has been executed, the processor 22 is then directed to return from the method 90 to the method 86 (FIG. 4) at block 96 thereof.

Referring back to FIG. 4, block 96 directs the processor 22 to provide a measurement result in accordance with the operating mode, such as that determined by block 88. Providing the measurement result may include providing a plurality of measurement results, such as by providing a plurality of measurement results from the same or different measurement sensor units, for example.

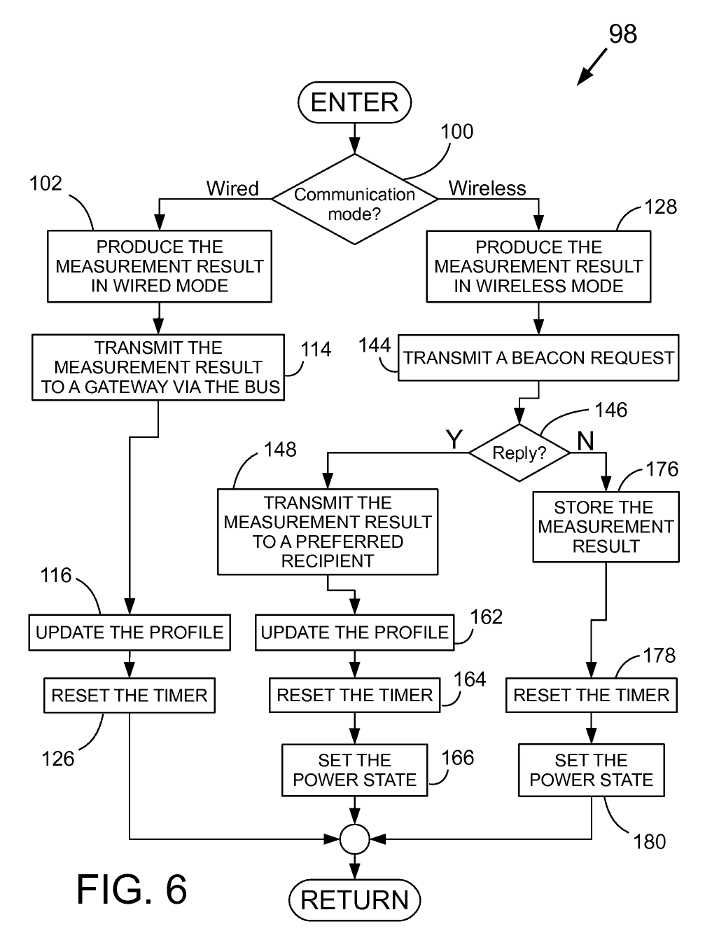

Referring to FIG. 6, an exemplary method for performing steps of block 96 is shown generally at 98. Method 98 begins at block 100, which directs the processor 22 to determine whether the communication mode of the data acquisition unit 16 is the wired communications mode or the wireless communications mode. Determining which communication mode is active may involve retrieving a communication mode indicator stored by block 94 (FIG. 5), executing or re-executing block 94, executing or re-executing block 88 (FIG. 4), or any combination thereof for example.

If the data acquisition unit 16 is in the wired communications mode, the processor 22 is directed to execute block 102.

Block 102 directs the processor 22 to produce the measurement result in accordance with the wired communications mode.

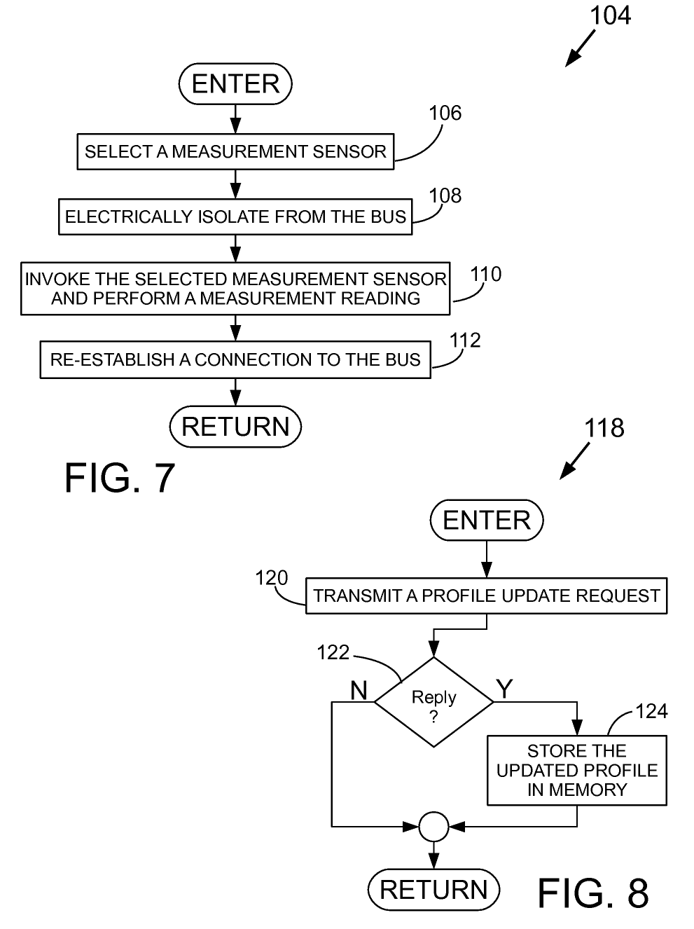

Referring to FIG. 7, an exemplary method for performing steps of block 102 is shown generally at 104. Method 104 begins at block 106, which directs the processor 22 to select a measurement sensor unit (not shown in FIGS. 1 to 7). The measurement sensor unit can be selected from among any measurement sensor units externally connected to the data acquisition unit 16 at the measurement sensor connectors 32 (FIG. 2).

Block 108 then directs the processor 22 to electrically isolate the data acquisition unit 16 from the communications bus in use for wired communications, which may be the CAN bus 20 (FIG. 1). In the first embodiment, isolating the data acquisition unit 16 from the CAN bus 20 may involve opening the bus switch 72, disconnecting the bus transceiver 70 at the measurement result switch 64, or any combination thereof for example. Isolating the data acquisition unit 16 from the CAN bus 20 advantageously permits performing measurements without the presence of a ground connection between the data acquisition unit 16 and the building 12 via the CAN bus 20, thereby removing a possible source of a ground loop connection that could otherwise adversely affect measurement accuracy.

Block 110 directs the processor 22 to invoke the selected measurement sensor unit and perform a measurement reading. In the first embodiment, invoking the selected measurement sensor unit involves closing the switching portion 44 (FIG. 3) of the measurement sensor switch 38 corresponding to the measurement sensor connector 32 (FIG. 2) connected to the selected measurement sensor unit. Closing the switching portion 44 permits the power supply voltage to be applied to the selected measurement sensor unit such that a voltage measurable at the buffer amplifier 60 input is indicative of a phenomenon related to the building 12.

In some embodiments, invoking the selected measurement sensor unit involves closing the reference switch 58, including closing the reference switch 58 for a predetermined amount of time and then opening the reference switch 58. Having the reference switch 58 closed during a settling time caused by closing the switching portion 44 advantageously reduces the time length of such settling time.

In the first embodiment, performing a measurement reading involves storing by the processor 22 in a memory such as the memory 24 the analog-to-digital converter 62 output, which may be considered a digital representation of the measurement result. In the first embodiment, the data acquisition unit 16 is operable to perform a measurement reading while either the reference switch 58 is open or closed. Performing the measurement reading while the reference switch 58 is open causes the measurement reading to be performed on the basis of the reference resistor 50 alone, which in ordinary circumstances advantageously provides a suitable, including possibly an optimal, input voltage level to the analog-to-digital converter 62. In contrasting circumstances, performing the measurement reading while the reference switch 58 is closed causes the measurement reading to be performed on the basis of the reference resistor 50 in parallel with the second reference resistor 56, thereby providing a lower voltage input level to the analog-to-digital converter 62, which in certain circumstances may advantageously provide a voltage input level that is closer to an optimal input voltage level for the analog-to-digital converter 62.

After block 110 has been executed, block 112 directs the processor 22 to re-establish a connection to the communications bus from which the data acquisition unit 16 was isolated by block 108. In the first embodiment, the processor 22 is directed to re-establish a connection to the CAN bus 20. Re-establishing the connection to the CAN bus 20 may involve closing the bus switch 72, re-connecting the bus transceiver 70 at the measurement result switch 64, or both closing the bus switch 72 and re-connecting the bus transceiver 70 at the measurement result switch 64.

In embodiments and circumstances where multiple measurements are being invoked, the method 104 may include multiple iterations of blocks 106 to 112, including multiple iterations of blocks 106 to 112 in which a different measurement sensor unit is selected with each iteration, or sequence of iterations, of block 106.

After block 112 has been executed, the processor 22 is then directed to return from the method 104 to the method 98 (FIG. 6) at block 114 thereof.

Referring back to FIG. 6, block 114 directs the processor 22 to transmit the measurement result, such as that produced by block 112, to a gateway, such as the gateway 18 (FIG. 1), via the communications bus, such as the CAN bus 20 (FIG. 1). Block 114 is preferably executed in accordance with the wired communications mode, and any suitable wired communications techniques may be employed.

In various embodiments, blocks 102 and 114 can be iteratively executed any number of times, including executing blocks 102 and 114 once for each measurement sensor unit connected to the data acquisition unit 16 and including executing blocks 102 and 114 multiple number of times.

Block 116 directs the processor 22 to update the profile of the data acquisition unit 16. In the first embodiment, each data acquisition unit 16 of the system 10 includes a profile for that data acquisition unit 16. Such profile may include any suitable parameter or other information for directing the operations of the data acquisition unit 16. For example, the profile may include the amount of time between measurements, or sets of measurements, to be provided by the data acquisition unit 16, or otherwise direct the frequency at which measurements are to be performed. The profile may include a time stamp for use in synchronizing an internal clock (not shown) of the data acquisition unit 16. Other profile parameters are possible.

In some embodiments, updating the profile includes transmitting to the gateway 18 logged event information, which may include the detection through the use of a measurement sensor unit of a notable fault condition such as a detected leak or extreme value of a measured quantity, for example. In some embodiments, updating the profile also involves activating an indicator, such as a LED (Light Emitting Diode) of the data acquisition unit 16, to indicate a fault condition, thereby advantageously facilitating locating by personnel the particular data acquisition unit 16 having detected such fault condition. Additionally or alternatively, such indicator at the data acquisition unit 16 may include a graphic visual indicator, such as a display on a LCD (liquid crystal display), audible indicator, tactile indicator such as a vibration, initiation of a mechanical force such as activation of an electromechanical or optical relay, and any combination thereof.

Referring to FIG. 8, an exemplary method for performing steps of block 116 (FIG. 6) is shown generally at 118. Method 118 begins at block 120, which directs the processor 22 to transmit a profile update request. In the first embodiment, the processor 22 is at least operable to transmit the profile update request to the gateway 18 via wired communications along the CAN bus 20. In some embodiments, transmitting the profile update request also includes transmitting event related information.

Block 122 then directs the processor 22 to determine whether a reply has been received in response to the profile update request. In the first embodiment, the data acquisition unit 16 is operable to wait as long as a predetermined amount of time for a reply and, if no reply has been received within such time to determine that no reply is forthcoming. Such amount of time may be selected to provide the gateway 18 with sufficient time to provide a reply in cases where an update to a profile is available, while not unduly delaying the data acquisition unit 16. The amount of time that a given data acquisition unit 16 will wait before determining that no reply is forthcoming may be a parameter of the profile of that given data acquisition unit 16.

In some embodiments, determining whether a reply is received may include determining that a reply has been received and determining whether the received reply includes a change in the profile. In such embodiments, where a received reply does not indicate any change in the profile, the data acquisition unit 16 is operable to treat such replies as if no reply had been received.

If a reply providing a profile, or updated profile, is received, then the processor 22 is directed to execute block 124.

Block 124 directs the processor 22 to store the updated profile in a memory, such as the memory 24. In at least some embodiments, the updated profile replaces a current profile in the memory 24. In some embodiments, however, a history of profiles may be stored in the memory 24 for subsequent retrieval and use.

After block 124 has been executed, the processor 22 is then directed to return from the method 118 to the method 98 (FIG. 6) at block 126 thereof.

Referring back to FIG. 6, block 126 directs the processor 22 to reset the timer. In the first embodiment, the timer is reset to a predetermined amount of time in accordance with the profile, including possibly the updated profile obtained by block 116, of the data acquisition unit 16 such that a next measurement, or set of measurements, is produced after the predetermined amount of time has elapsed. In some embodiments, resetting the timer includes setting the timer to a calculated amount of time that is determined in response to a previously produced measurement result, such as the measurement result most recently produced in accordance with block 102. Additionally or alternatively, the calculated amount of time may be determined on the basis of a plurality of previously produced measurement results, or an average thereof, produced in accordance with block 102. Resetting the timer to such calculated amount of time advantageously permits the data acquisition unit 16 to adapt the frequency at which measurement results are produced, thereby facilitating the increased collection of measurement results for critical circumstances while facilitating the decreased collection of measurement results for non-critical circumstances.

If at block 100 of FIG. 6 the processor 22 determines that the communication mode of the data acquisition unit 16 is the wireless communications mode, then the processor 22 is directed to execute block 128.

Block 128 directs the processor 22 to produce the measurement result in accordance with the wireless mode.

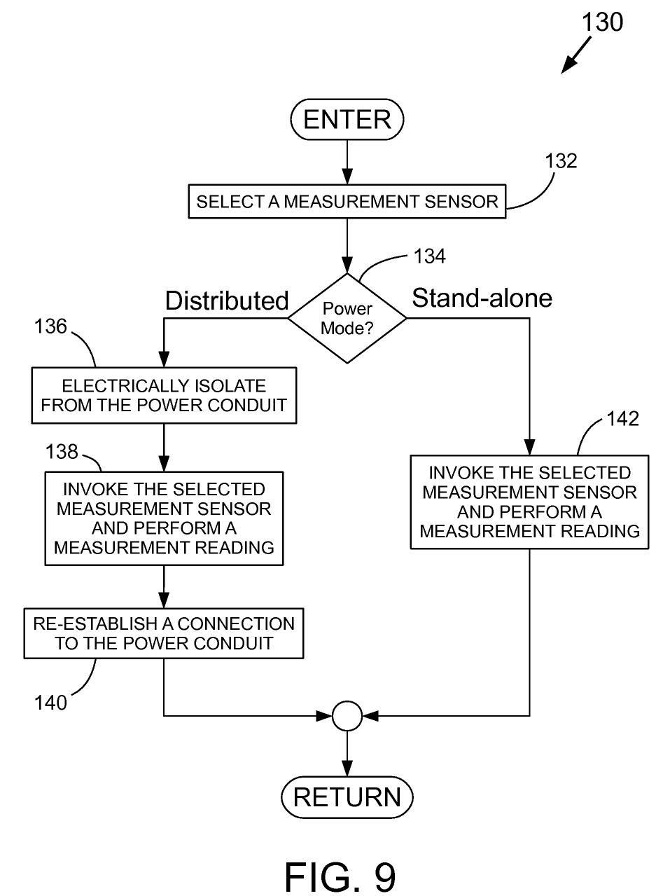

Referring to FIG. 9, an exemplary method for performing steps of block 128 is shown generally at 130. Method 130 begins at block 132, which directs the processor 22 to select a measurement sensor unit (not shown in FIGS. 1 to 9). Block 132 may be implemented in any suitable manner, including a manner identical, similar, analogous or different to the implementation of block 106 (FIG. 7) described herein above, for example.

Block 134 then directs the processor 22 to determine whether the power mode of the data acquisition unit 16 is the distributed mode or the stand-alone mode. Determining which power mode is active may involve retrieving a communication mode indicator stored by block 92 (FIG. 5), by executing or re-executing block 92, by executing or re-executing block 88 (FIG. 4), or any combination thereof for example.

If the data acquisition unit 16 is in the distributed power mode, the processor 22 is directed to execute block 136.

Block 136 directs the processor 22 to electrically isolate the data acquisition unit 16 from any power conduit (not shown) connected to the data acquisition unit 16, such as any power conduit connected to the data acquisition unit 16 at the distributed power connector 76 (FIG. 2). In the first embodiment, isolating the data acquisition unit 16 from the power conduit involves setting the power mode switch 80 such that the distributed power connector 76 is disconnected from the remainder of the data acquisition unit 16. Isolating the data acquisition unit 16 from the power conduit advantageously permits performing measurements without the presence of a ground connection between the data acquisition unit 16 and the building 12 via the power conduit, thereby removing a possible source of a ground loop connection that could otherwise adversely affect measurement accuracy.

In some embodiments, executing block 136 includes isolating the data acquisition unit 16 from any communications bus connected to the bus connector 74, such as by executing steps of block 108 (FIG. 7). Additionally or alternatively, executing block 108 may involve isolating the data acquisition unit 16 from any power conduit connected to the data acquisition unit 16 such as at the distributed power connector 76 (FIG. 2). In at least some embodiments, executing blocks 136 and 108 each involve disconnecting both the bus connector 74 and the distributed power connector 76 from the remainder of the data acquisition unit 16. For example, the bus switch 72 and the power mode switch 80 may both be opened, regardless of whether or not any connections have been made to the bus connector 74 and the distributed power connector 76.

Block 138 then directs the processor 22 to invoke the selected measurement sensor unit and perform a measurement reading. Block 138 may be implemented in any suitable manner, including a manner identical, similar, analogous or different to the implementation of block 110 (FIG. 7) described herein above, for example.

After block 138 has been executed, block 140 directs the processor 22 to re-establish a connection to the power conduit from which the data acquisition unit 16 was isolated by block 136. Re-establishing the connection to the power conduit may involve setting the power mode switch 80 such that the distributed power connector 76 is re-connected to the remainder of the data acquisition unit 16.

In some embodiments, executing block 140 includes re-establishing a connection to any communications bus connected to the bus connector 74, such as by executing steps of block 112 (FIG. 7). Additionally or alternatively, executing block 112 may involve re-establishing a connection to any power conduit connected to the data acquisition unit 16 such as at the distributed power connector 76 (FIG. 2). In at least some embodiments, executing blocks 140 and 112 each involve re-connecting both the bus connector 74 and the distributed power connector 76 to the remainder of the data acquisition unit 16. For example, the bus switch 72 and the power mode switch 80 may both be closed, regardless of whether or not any connections have been made to the bus connector 74 and the distributed power connector 76.

If at block 134 of FIG. 9 the processor 22 determines that the power mode of the data acquisition unit 16 is the stand-alone power mode, then the processor 22 is directed to execute block 142.

Block 142 directs the processor 22 to invoke the selected measurement sensor unit and perform a measurement reading. Block 142 may be implemented in any suitable manner, including a manner identical, similar, analogous or different to the implementation of block 138, block 110 (FIG. 7) or both block 138 and block 110, which are described herein above, for example.

Although not shown in FIG. 9, the data acquisition unit 16 is in at least some embodiments operable to electrically isolate the distributed power connector 76 from the remainder of the data acquisition unit 16, such as by executing block 136, before executing block 142. Additionally or alternatively, the data acquisition unit 16 is operable to re-establish the connection between the distributed power connector 76 from the remainder of the data acquisition unit 16, such as by executing block 140, after executing block 142.

In some embodiments, blocks 136 to 140 are executed instead of block 142 regardless of the power mode of the data acquisition unit 16. In such embodiments, the method 130 need not include block 134 and the method 130 may proceed directly from block 132 to blocks 136 to 140.

In embodiments and circumstances where multiple measurements are being invoked, the method 130 may include multiple iterations of blocks 132 to 142, including multiple iterations of blocks 132 to 142 in which a different measurement sensor unit is selected with each iteration, or sequence of iterations, of block 132.

After either block 140 or block 142 has been executed, the processor 22 is then directed to return from the method 130 to the method 98 (FIG. 6) at block 144 thereof.

Referring back to FIG. 6, block 144 directs the processor 22 of the given data acquisition unit to transmit a beacon request. In the first embodiment, transmitting a beacon request involves transmitting by wireless communications a communication containing a request for identifications of data acquisition units or other devices operable to communicate with the given data acquisition unit 16, and for the hop count of such other data acquisition units or other devices. Typically, any data acquisition unit 16 in wired communication with the gateway 18 has a hop count of zero. A data acquisition unit 16 operating in the wireless communications mode typically has a hop count of one or greater. In some embodiments, transmitting the beacon request involves transmitting a request for a profile or an update to a profile.

Block 146 then directs the processor 22 of the given data acquisition unit 16 to determine whether a reply has been received in response to the beacon request. In the first embodiment, the given data acquisition unit 16 is operable to wait as long as a predetermined amount of time for a reply and, if no reply has been received within such time to determine that no reply is forthcoming. Such amount of time may be selected to provide other data acquisition units 16 in the vicinity of the given data acquisition unit 16 with sufficient time to provide a reply, while not unduly delaying the given data acquisition unit 16. The amount of time that a given data acquisition unit 16 will wait before determining that no reply is forthcoming may be a parameter of the profile of that given data acquisition unit 16. Determining whether a reply is forthcoming may include storing information provided in any replies that are received, such by storing identifications and hop counts provided in received replies in a memory such as the memory 24 for subsequent retrieval.

If a reply responding to the beacon request is received, then the processor 22 is directed to execute block 148. In some embodiments where transmitting the beacon request involves transmitting a request for a profile or an update to a profile, executing block 146 may also involve determining whether any reply received in response to the beacon request includes a profile or an update to a profile, and storing the profile or update thereof. Additionally or alternatively, a profile may be updated by the execution of further blocks described herein below.

Block 148 directs the processor 22 to transmit the measurement result to a preferred recipient.

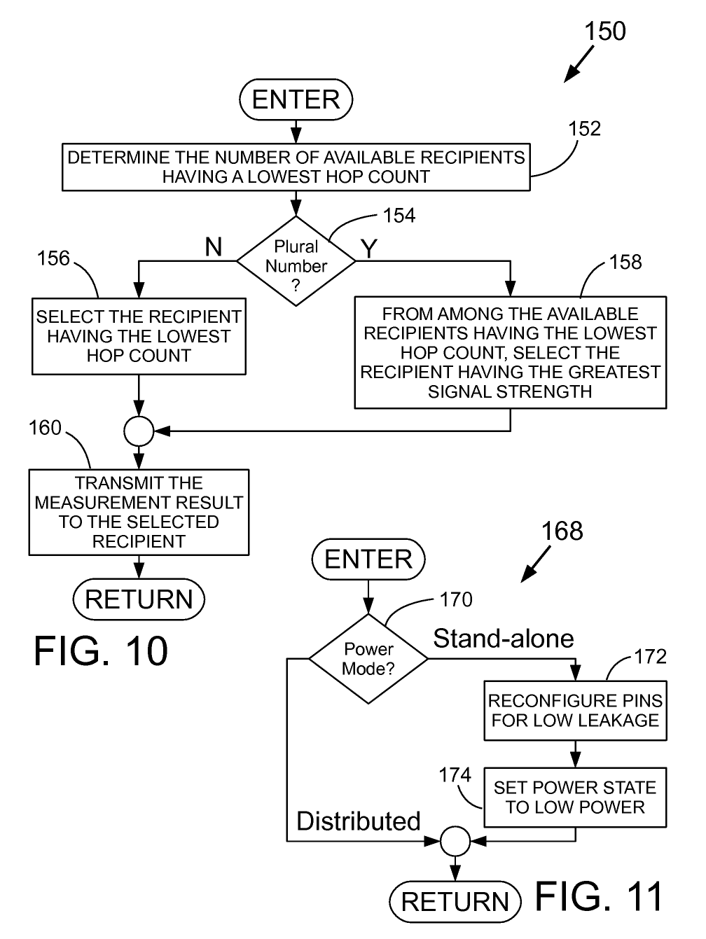

Referring to FIG. 10, an exemplary method for performing steps of block 148 (FIG. 6) is shown generally at 150. Method 150 begins at block 152, which directs the processor 22 of the given data acquisition unit 16 to determine the number of available recipients having a lowest hop count. In the first embodiment, such available recipients are other data acquisitions units 16 or other devices operable to communicate with the given data acquisition unit 16 that have provided to the given data acquisition unit 16 a reply to the beacon request transmitted in accordance with block 144 (FIG. 6). In the first embodiment, the given data acquisition unit 16 is operable to compare hop counts contained in replies received in response to the beacon request such that a lowest hop count may be determined.

For example, if 6 replies from available recipients are received, 3 of which specify hop counts of one, 2 of which specify hop counts of two, and 1 of which specifies a hop count of three, then the lowest hop count is one. In such example, executing block 152 results in the determination of 3 as the number of available recipients having the lowest hop count of one. Other determinations are possible, including determining any plural number of available recipients have a lowest hop count and determining that only one available recipient has a lowest hop count.

After block 152 is executed, the processor 22 is directed to execute block 154.

Block 154 directs the processor 22 to determine whether a plural number was determined by block 152.

If the number of available recipients having a lowest hop count is not a plural number, the processor 22 is directed to execute block 156, which directs the processor 22 to select the recipient having the lowest hop count. In the first embodiment, the selected available recipient is the one available recipient having provided in a reply to the beacon request a hop count lower than all other hop counts contained in any other replies received in response to the beacon request.

If the number of available recipients having a lowest hop count is a plural number, then the processor 22 is directed to execute block 158, which directs the processor 22 to select, from among that plural number of available recipients having the lowest hop count, the one available recipient having the signal strength. In the first embodiment, the given data acquisition unit 16 is operable to determine a wireless communications signal strength corresponding to replies received by wireless communications in response to the beacon request. Such wireless communications signal strength may be determined by RSSI (Received Signal Strength Indication) technology, for example. In the first embodiment, the given data acquisition unit 16 is advantageously operable to select a nearest neighbour, as measured by signal strength, among neighbouring data acquisition units 16 having a minimal hop count, thereby enhancing wireless communications between the given data acquisition unit 16 and the gateway 18. Additionally or alternatively, the given data acquisition unit 16 is operable in some embodiments to select a nearest neighbour geographically by determining or receiving the location of one or more other data acquisition units 16. The location of such other data acquisition units 16 may be determined by the use of a GPS (Global Positioning System) or similar.

After either block 156 or block 158 has been executed, the processor 22 is directed to execute block 160.

Block 160 directs the processor 22 to transmit the measurement result to the selected recipient. In the first embodiment, the given data acquisition unit 16 is operable to transmit the measurement result obtained by block 128 (FIG. 6) to the available recipient selected by executing either block 156 or block 158. Such transmission in the first embodiment is preferably by wireless communications in accordance with the identification contained in the reply to the beacon request received from the selected available recipient.

In the first embodiment, executing block 160 also involves transmitting an identification of the source of the communication, which by way of example may be the given data acquisition unit 16 having produced the measurement result in accordance with block 128 (FIG. 6).

After executing block 160, the method 150 ends and the process returns to the method 98 (FIG. 6) at block 162.

Referring back to FIG. 6, block 162 directs the processor 22 to update the profile. In some embodiments, the profile may be updated by executing blocks 144 and 146, for example. In such embodiments, block 162 may not need to be executed, but may be executed in addition to executing blocks 144 and 146.

Referring to FIG. 8, an exemplary method for performing steps of block 162 (FIG. 6) is shown generally at 118. Method 118 begins at block 120, which directs the processor 22 to transmit a profile update request. In the first embodiment, the processor 22 is operable to transmit the profile update request to the gateway 18 via wired communications along the CAN bus 20, and is also operable to transmit the profile update request to the gateway 18 via wireless communications with the preferred recipient selected in accordance with block 148 (FIG. 6). Typically, a given data acquisition unit 16 will transmit the profile update request via wired communications when in the wired communications mode and will transmit the profile update request via wireless communications when in the wireless communications mode. In the wireless communications mode, the given data acquisition unit 16 preferably transmits the profile update request to the preferred recipient, which then re-transmits the profile update request toward the gateway 18. Further re-transmissions may occur depending on the arrangement of data acquisition units 16 in a given system 10 installation. In the first embodiment, transmitting a profile update request in accordance with block 120 involves determining which communication mode is active, such as by executing block 100 (FIG. 6) and transmitting the profile update request in accordance with the active communication mode.

After block 120 has been executed, then block 122 is executed and block 124 is executed if block 122 determines that a reply has been received, as described in further detail herein above. Thereafter, the method 118 ends and the processor 22 is directed to return to processing the method 98 (FIG. 6) at block 164.

In some embodiments where transmitting a beacon request, such as by executing block 144 (FIG. 6) involves transmitting a request for a profile or an update to a profile, then method 188 may involve executing block 124 only, for example. In some embodiments,

Referring back to FIG. 6, block 164 directs the processor 22 to reset the timer. Block 164 may be implemented in any suitable manner, including a manner identical, similar, analogous or different to the implementation of block 126 described herein above. For example, the data acquisition unit 16 is operable to reset the timer in accordance with the profile, including possibly the updated profile obtained by block 162, of the data acquisition unit 16. By way of further example, the data acquisition unit 16 is operable in at least some embodiments to set the timer to a calculated amount of time that is determined in response to one or more measurement results produced in accordance with block 128.

Block 166 then directs the processor 22 to set the power state of the data acquisition unit 16.

Referring to FIG. 11, an exemplary method for performing steps of block 166 (FIG. 6) is shown generally at 168. Method 168 begins at block 170, which directs the processor 22 to determine which power mode is active. In the first embodiment, the power mode is either the distributed power mode or the stand-alone power mode. However, other power modes are possible.

In the first embodiment, if the stand-alone power mode is active the processor 22 is directed to execute block 172. Block 172 directs the processor 22 to reconfigure pins of the processor 22 for low leakage. By way of example, the memory 24 may contain information, such as in a look-up table, of the various possible states of processor 22 pins and/or an indication as to which state for each processor 22 pin is associated with a lowest leakage current through that pin. In some embodiments, executing block 172 involves configuring pins of multiple integrated circuits of the data acquisition unit 16 for low leakage. Executing block 172 advantageously minimizes leakage current during the duration of a low power state of the data acquisition unit 16.

Block 174 then directs the processor 22 to set the power state of the data acquisition unit 16 to the low power state. In the first embodiment, such low power state may be considered a sleep state of the processor 22 and other integrated circuits of the data acquisition unit 16. Block 174 advantageously minimizes power usage in the stand-alone power mode while the data acquisition unit 16 awaits in accordance with the predetermined amount of time before the next measurement, or set of measurements, is produced.

In the first embodiment, if the distributed power mode is active the processor 22 is directed to end the method 168. For a given data acquisition unit 16 in the distributed power mode, not entering the low power state in the distributed power mode advantageously permits the given data acquisition unit 16 to be available for receiving communications from other data acquisition units 16 or other devices operable to communicate with the given data acquisition unit 16. In some embodiments, the given data acquisition unit 16 is operable to enter the low, or a lower, power state in the distributed power mode while still retaining the ability to receive communications from other devices, and to re-enter full power mode when needed to act upon such received communications or request a retransmission of such received communications. In some embodiments, the data acquisition unit 16 is operable to enter a low, or lower, power state regardless of the power mode. Conversely, in some embodiments the data acquisition unit 16 is operable to refrain from entering a low, or lower, power state regardless of the power mode.

After block 174, or block 170 in the distributed power mode, has been executed, the processor 22 is directed to return from the method 168 to the method 98 (FIG. 6) following block 166 thereof.

If at block 146 of FIG. 6 the processor 22 determines that no reply in response to the beacon request (block 144) has been received, then the processor 22 is directed to execute block 176.

Block 176 directs the processor 22 to store the measurement result, which may be the measurement result produced by block 128. In the first embodiment, the data acquisition unit 16 is operable to store the measurement result in the memory 24. In some embodiments, the data acquisition unit 16 is operable to store a measurement count in association with the measurement result such that, upon re-establishment of wireless communications, all stored measurement results can be provided to the gateway 18 in association with a measurement count. In the first embodiment, the gateway 18 is operable to determine, such as by retrieval from a database (not shown in the Figures) of or in communication with the gateway 18, the predetermined amount of time elapsed between each measurement, or set of measurements, produced by the data acquisition unit 16, thereby permitting the gateway 18 to track the times at which all measurements provided by the data acquisition unit 16 were produced. In some embodiments, the data acquisition unit 16 need only provide to the gateway 18 the order in which the measurements, or sets thereof, were produced for the gateway 18 to be able to back-calculate the time at which each measurement, or set of measurements, were produced. For example, upon re-establishment of wireless communications, the data acquisition unit 16 may be operable to transmit measurement results in the order in which they were produced. In some embodiments, the data acquisition unit 16 is operable to time stamp each measurement, such as by associating current time information with each measurement produced by the data acquisition unit 16, thereby relieving the gateway 18 of the task of calculating measurement times from an associated order of measurements or associated measurement counts. Additionally or alternatively, the time at which the gateway 18 (FIG. 1) receives a measurement, or set of measurements, may be determined and possibly tracked or otherwise stored for subsequent use, including possibly being tracked by the gateway 18 and not tracked by the data acquisition unit 16. In some embodiments, the time at which a measurement, or set of measurements, is produced is not tracked.

Block 178 then directs the processor 22 to reset the timer. Block 178 may be implemented in any suitable manner, including a manner identical, similar, analogous or different to the implementation of block 126, block 164, or both block 126 and block 164, described herein above. For example, the data acquisition unit 16 is operable to reset the timer in accordance with a previously stored profile of the data acquisition unit 16, without updating the profile if wireless communications are unavailable.

In some embodiments, a given data acquisition unit 16 is operable to reset the timer in accordance with a stored timing value regardless of any timing value contained within the profile for that given data acquisition unit 16. In such embodiments, the system 10 is operable to provide the same timing value contained within the same or different profiles to a plurality of data acquisition units 16, while permitting particular ones of the plurality to ignore the timing value contained within the received profile. The particular ones of the plurality may be selected in accordance with the particular measurement sensor units connected and in use by such particular data acquisition units 16, for example.

Block 180 then directs the processor 22 to set the power state of the data acquisition unit 16. Block 180 may be implemented in any suitable manner, including a manner identical, similar, analogous or different to the implementation of block 166 described herein above.

Still referring to FIG. 6, in the first embodiment executing block 148 also involves transmitting any previously stored measurement results with the current measurement result to the preferred recipient, thereby advantageously providing past measurements results upon re-establishment of communications.

In variations of embodiments, the data acquisition unit 16 is operable to store measurement results and provide a set of such measurement results regardless of whether communications are temporarily suspended. In such embodiments, blocks 144 to 148 and 162 to 166 need not be executed during iterations of the method 98 in which such set of measurement results are not being provided to the gateway 18. In some embodiments, the data acquisition unit 16 is operable to provide an event indicator in addition or in the alternative to providing a measurement result or set thereof. For example, the data acquisition unit 16 could provide an alarm indication upon one or more measurement results, including an average of such measurement results, that exceed a specifiable threshold. In some embodiments, each measurement result provided by the data acquisition unit 16 is an average of a plurality of results of measurements performed in accordance with method steps described herein.

In some embodiments, block 146 and blocks 176 to 180 are not executed for each new iteration of the method 98. In such embodiments, after block 128 has been executed the processor 22 is directed to execute block 148, followed by blocks 162 to 166. In some embodiments, the method 98 involves transmitting a beacon request until a first reply is received, determining the preferred recipient, and storing identification information associated with such preferred recipient for subsequent iterations of block 148. In such subsequent iterations of block 148, the data acquisition unit 16 need not execute blocks 146 and 176 to 180. In some embodiments, the preferred recipient is stored within the memory 24 upon installation and blocks 146 and 176 to 180 are never executed. Other variations of the method 98 are possible.

After any one of blocks 126, 166 or 180 has been executed, the processor 22 is directed to end the method 98 and return to the method 86 (FIG. 4) following block 96.

Referring back to FIG. 4, after block 96 has been executed, the processor 22 is directed to end the method 86. In the first embodiment, the data acquisition unit 16 is operable to start the method 86 after the predetermined amount of time to which the timer had been set by any one of blocks 126, 164 or 178 has elapsed, thereby advantageously permitting the data acquisition unit 16 to provide a measurement result, or set of measurement results, at predetermined intervals of time. In the first embodiment, such predetermined intervals of time are adjustable in accordance with steps for updating the profile of the data acquisition unit.

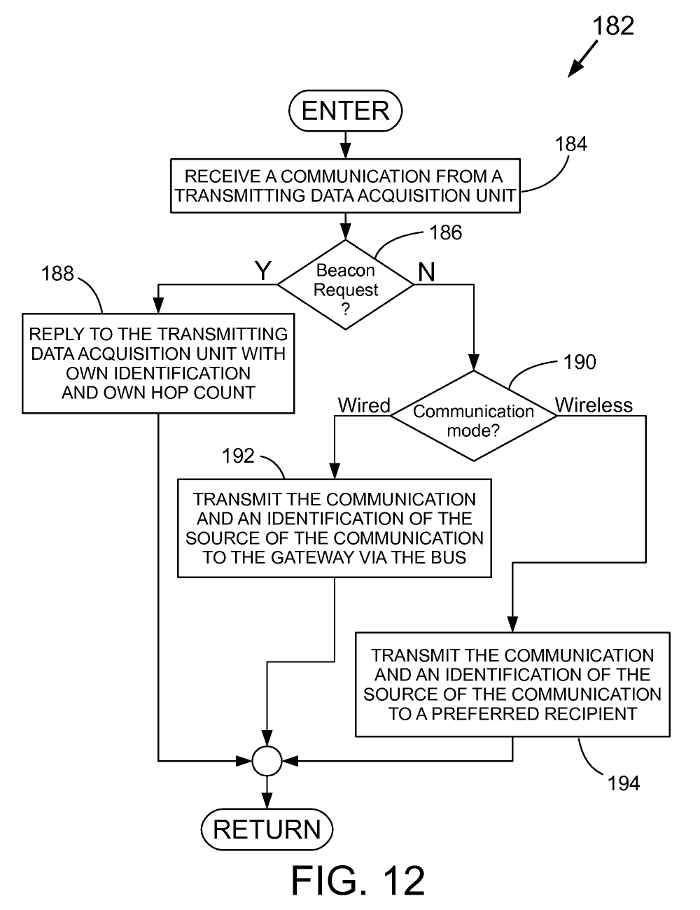

While FIG. 4 shows block 88 being executed in its entirety prior to block 96 being executed, other arrangements are possible. For example, the determination of either or both of the power mode and the communication mode may be delayed until needed. In variations, block 92 can be executed at any time prior to or concurrent with executing block 134 (FIG. 9) and/or block 170 (FIG. 11). Similarly, block 94 of FIG. 4 may be executed at any time prior to or concurrent with executing block 100 (FIG. 6) and/or block 190 (FIG. 12).

Referring to FIG. 12, an exemplary method in accordance with the first embodiment of the invention is shown generally at 182. The method 182 advantageously permits a given data acquisition unit 16 to receive and act upon communications received from other data acquisition units 16 or other devices operable to communicate with the given data acquisition unit 16. In accordance with the first embodiment, the given data acquisition unit 16 is operable to receive such communications by wireless transmission while in the full power state. However, other arrangements are possible.

The method 182 begins at block 184, which directs the given data acquisition unit 16 to receive a communication from a transmitting data acquisition unit 16. In the first embodiment, the communication includes an identification of a source of the communication, which may be the transmitting data acquisition unit 16. Additionally or alternatively, the source of the communication may be a first transmitting data acquisition unit 16 in a chain of transmitting data acquisition units 16, for example.

Block 186 then directs the processor 22 to determine whether or not the transmitted communication is a beacon request, such as a beacon request transmitted in accordance with block 144 (FIG. 6). Block 186 advantageously permits the given data acquisition unit 16 to reply to beacon requests and to re-transmit communications intended for the gateway 18.

If the transmitted communication is a beacon request, block 188 directs the processor 22 to reply to the transmitting data acquisition unit 16 with the identification and hop count of the given data acquisition unit 16. Block 188 advantageously permits the transmitting data acquisition unit 16 to include the given data acquisition unit 16 in its selected of a preferred recipient in accordance with block 148 (FIG. 6), for example. In some embodiments, replying to the transmitting data acquisition unit 16 includes transmitting a profile, such as a copy of the profile in use by the given data acquisition unit 16. In such embodiments, separately updating the profile may not need be performed, but may be performed in addition to the communications associated with beacon requests and corresponding replies.

If the transmitted communication is not a beacon request, block 190 directs the processor 22 to determine which communication mode is active for the given data acquisition unit 16.

If by block 190 the processor 22 determines that the given data acquisition unit 16 is operating in the wired communication mode, the processor 22 is directed to execute block 192.

Block 192 directs the processor 22 to transmit the transmitted communication and an identification of the source of the communication to the gateway 18 via the bus, such as the CAN bus 20. In the first embodiment, the originating data acquisition unit 16 is operable when transmitting a communication toward the gateway 18, for example by transmitting the communication to its preferred recipient such as in accordance with block 148 (FIG. 6), to also transmit its identification. In accordance with block 192, the given data acquisition unit 16 having received the transmitted communication is operable to re-transmit the communication and the identification of the source of the communication. Doing so may involve replacing its own identification in its own data packet headers with the identification contained within the data packet header of the transmitted communication received by it, thereby advantageously transmitting an identification of the source of the communication while minimizing data transmission overhead.

If by block 190 the processor 22 determines that the given data acquisition unit 16 is operating in the wireless communication mode, the processor 22 is directed to execute block 194.

Block 194 directs the processor 22 of the given data acquisition unit 16 to transmit the transmitted communication and an identification of the source of the communication to a preferred recipient selected by the given data acquisition unit 16. The preferred recipient may be selected in any suitable manner, including a manner identical, similar, analogous or different to the manner in which a preferred recipient is selected in accordance with the method 150 (FIG. 10) described herein above.

After any one of blocks 188, 192 or 194 has been executed, the processor 22 is directed to end the method 182.

Thus, there is provided a method of monitoring a structure, the method comprising: (a) receiving at a first connector of a measurement acquisition unit a sensor unit electrically connected to the structure; and (b) invoking said sensor unit so as to produce a measurement result for monitoring the structure, wherein invoking said sensor unit so as to produce a measurement result for monitoring the structure comprises electrically isolating a second connector of said measurement acquisition unit from said first connector.

### Prior Art Leak Detection Tape

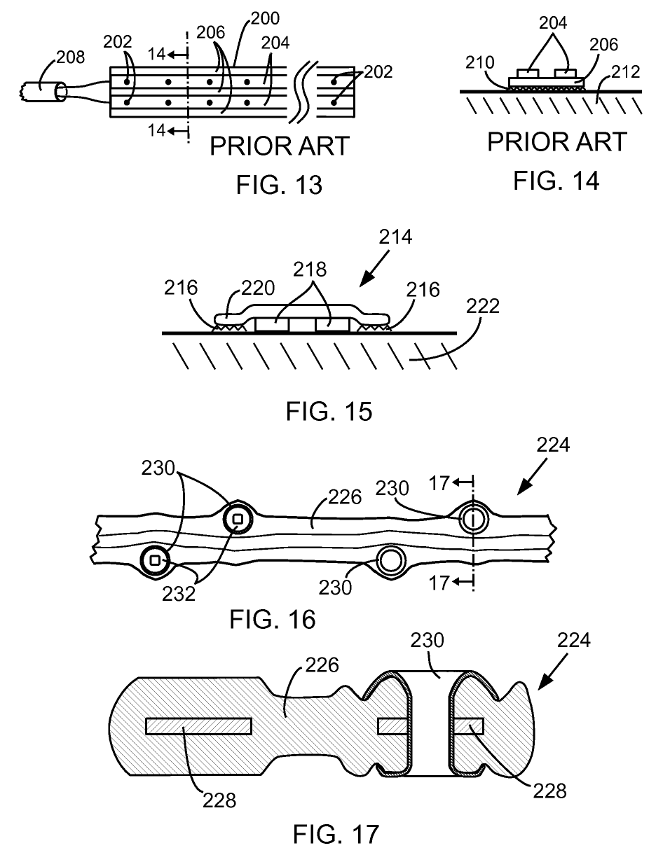

Referring to FIGS. 13 and 14, a prior art leak detection tape 200 having a plurality of probes 202 inserted through a pair of spaced apart conductors 204 and a substrate 206 is shown. The pair of conductors 204 are attached at one end to a cable 208 and unattached at the opposing end. The electrical resistance measured between the pair of conductors 204 is ordinarily infinite (i.e. an open circuit). However, when a liquid such as water is disposed across the pair of conductors 204, the electrical resistance becomes very low (i.e. a short circuit condition results), thereby detecting the presence of the liquid.

A cross sectional view of the prior art leak detection tape 200 is shown in FIG. 14. The leak detection tape 200 includes an adhesive layer 210 for adhering the back of the leak detection tape 200 to the surface of a floor 212 (not shown).

The probes 202 are nails or screws inserted into the floor 212. If the floor 212 becomes moist, such moisture content of the floor 212 lowers the electrical resistance between the probes 202, thereby measuring moisture content of the floor 212.

### Measurement Sensors

A measurement sensor for monitoring a structure includes: (a) measurement sensing means for measuring a feature of the structure; and (b) connection test means for indicating an impaired connection of said measurement sensor, said connection test means being electrically connectable in parallel with said measurement sensing means and having a finite impedance such that when said connection test means is connected an impedance of said measurement sensor greater than said finite impedance indicates said impaired connection.

Referring to FIG. 15, an encloseable moisture content sensor in accordance with embodiments of the invention is shown generally at 214. The inventive encloseable moisture content sensor 214 includes two spaced apart adhesive layers 216 at opposing sides along the encloseable moisture sensor 214. The pair of adhesive layers 216 are disposed on the front of the encloseable moisture sensor 214 in conjunction with a pair of spaced apart conductors 218, which are attached to a backing material 220. In variations of embodiments, the pair of adhesive layers 216 may be disposed along any portion of the backing material, including being disposed along the entire front surface of the backing material 216 so as to form a single adhesive layer. The adhesive layers 216 may include adhesive suitable for adhering the conductors 218 to the backing material 220 along its front surface. The encloseable moisture content sensor 214 preferably also includes one or more peel-off layers (not shown) for protecting the pair of adhesive layers prior to installation.

The encloseable moisture content sensor 214 in at least some embodiments is dimensioned to permit probes (not shown) to be inserted through the backing material 220 into the surface of a building material 222, which may be a wall, floor, ceiling and/or roof, frame member, joist or similar for example. The encloseable moisture content sensor advantageously facilitates the measurement of moisture content of the building material 222 while avoiding inaccuracies in such measurement that may be caused by substances external to the building material 222, including dust, oil, grease or fluids for example. The encloseable moisture content sensor 214 is dimensioned for connection to a device, such as the data acquisition unit 16 (FIGS. 1 and 2) described herein above, operable to perform measurements, such as by invoking the encloseable moisture content sensor 214 and performing a measurement reading therefrom.

Referring to FIGS. 16 and 17, a moisture content sensor in accordance with embodiments of the invention is shown generally at 224. The inventive moisture content sensor 224 includes an enclosure made of an electrically insulating material, such as the electrically insulating housing 226 shown in FIGS. 16 and 17. Within the housing 226 are disposed a pair of spaced apart conductors 228 best seen in the cross sectional view of FIG. 17. In some embodiments, the housing 226 forms a sheath around each of the conductors of the pair 228. Such conductors may be made of any suitable electrically conductive material, including being single or multi-strand copper wires or strips, for example. The moisture content sensor 224 is dimensioned for connection to a device, such as the data acquisition unit 16 (FIGS. 1 and 2) described herein above, operable to perform measurements, such as by invoking the moisture content sensor 224 and performing a measurement reading therefrom.

The moisture content sensor 224 is preferably able to receive one or more probe supports such as the eyelet rivets 230 shown in FIGS. 16 and 17. Each eyelet rivet 230 is dimensioned to be able to receive a probe 232, which may be any electrically conductive object suitable for inserting through the eyelet rivet 230 into a building 12 material. Examples of probes 232 include nails, screws, bolts, male rivets, staples, pegs, needles and other electrically conductive objects. The probe supports of the moisture content sensor 224 are preferably attachable to the housing 226 in a manner that facilitates manufacturing of the moisture content sensor 224, such as by riveting the probe supports to the housing 226. The use of eyelet rivets 230 that can be riveted to the housing 226 advantageously facilitates manufacturing of the moisture content sensor 224. The eyelet rivets 230 may be located anywhere along the conductors 228, including being located in transverse alignment to each other. The eyelet rivets 230 may be attached to the moisture content sensor 224 by any suitable technique, including by riveting for example.

In some embodiments, the housing 226 includes one or more perforations (not shown), such as holes, slits, cuts or similar, to selectively exposing the pair of conductors 228. The perforations may be regularly spaced apart along the length of the housing 226, for example. The perforations may advantageously facilitate the detection by the moisture content sensor 224 of surface moisture such as leaks, flood conditions, etc. In embodiments where the housing 226 includes both perforations and probe supports, the perforations are typically not in contact with the probe supports.

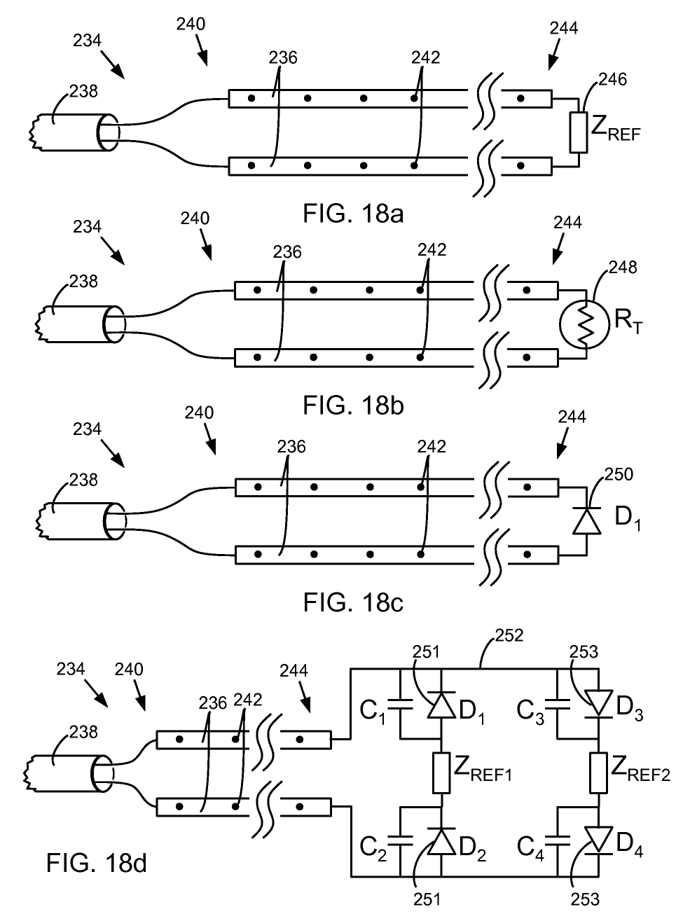

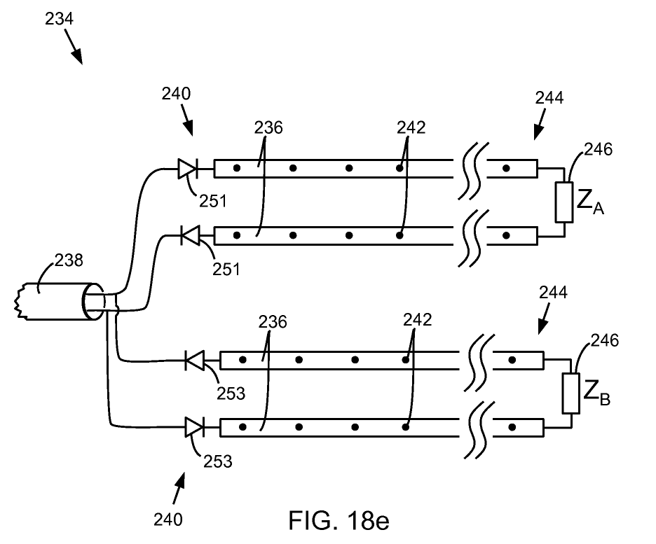

FIGS. 18a to 18e show variations of a measurement sensor 234 in accordance with embodiments of the invention. Each measurement sensor 234 includes a pair of spaced apart conductors 236 having a cable 238 attached at a connection end 240 of the measurement sensor 234. The measurement sensor 234 at its connection end 240, the cable 238 at least one end thereof, or both the measurement sensor 234 at its connection end 240 and the cable 238 are dimensioned for connection to a device, such as the data acquisition unit 16 (FIGS. 1 and 2) described herein above, that is operable to perform measurements, such as by invoking the measurement sensor 234 and performing a measurement reading therefrom. Not all embodiments need include the cable 238. Probes 242 are shown attached, inserted through or otherwise in electrical contact with the conductors of the pair 236. In some embodiments, the measurement sensor 234 includes an electrically insulating substrate (not shown) for supporting the pair of conductors 236, and such substrate may be adhesive-backed and include a peel-off layer.

Each measurement sensor 234 includes at a terminal end 244 opposite to the connection end 240 an impedance circuit, which may include any combination of electrical components or circuitry, for example. Exemplary impedance circuits include the reference impedance 246 shown in FIG. 18a, the thermistor 248 shown in FIG. 18b, the diode 250 shown in FIG. 18c, the dual reference impedance circuit 252 shown in FIG. 18d, and the first reference impedance 246 and the second reference impedance 246 shown in FIG. 18e. One or more impedance circuits may be electrically connected in parallel with the pair of conductors 236 including as shown in FIGS. 18a to 18e. A connected impedance circuit preferably has a finite impedance such that the parallel impedance of the pair of conductors 236 in parallel with the connected impedance circuit indicates an impairment of an electrical connection of the measurement sensor 234 if the parallel impedance is greater than the finite impedance of the connected impedance circuit alone. Although FIGS. 18a to 18e show the impedance circuit connected to the measurement sensor 234 at the terminal end 244, in general the impedance circuit may be applied at either or both ends of the measurement sensor 234 or cable 238 thereof, at either or both ends of the moisture content sensor 224 (FIGS. 16 and 17), at either or both ends of the encloseable moisture content sensor 214 (FIG. 15), or any combination thereof.

Referring to FIG. 18a, the reference impedance 246 may have any suitable finite impedance. In some embodiments, the reference impedance 246 will vary with frequency and may only be a finite impedance within a specifiable frequency range. The reference impedance 246 advantageously permits a device such as the data acquisition unit 16 (FIGS. 1 and 2) to determine whether an electrical connection between the device and the reference impedance 246 has been impaired, including detecting a complete disconnection. The measurement sensor 234, including the reference impedance 246, is generally able to receive from the device a DC voltage, DC current, AC voltage, AC current, a waveform such as a pulse, or other electrical stimulation. For example, the measurement sensor 234 may be invoked by the application of a DC voltage, in which case insufficient current resulting therefrom indicates an impaired connection between the device and the reference impedance 246. Such impaired connection may be at the connection between the device and the measurement sensor 234, within the cable 238 if present, at the connection between the cable 238 and the pair of conductors 236, along the pair of conductors 236, at the connection between the pair of conductors 236 and the reference impedance 246, within the reference impedance 246, or any combination thereof. By way of further example, the exact location of an impaired connection or an indication that no impaired connection exists can be determined by applying a time-domain reflectometry (TDR) waveform to the measurement sensor 234 for a TDR measurement. In some embodiments, the reference impedance 246 has a precision impedance value, possibly including a precision resistance value, to facilitate use of the measurement sensor 234 when no impairment of electrical connectivity is occurring. Additionally or alternatively, in some embodiments the impedance value of the reference impedance 246 can be calibrated for use with the device.

Referring to FIG. 18b, the thermistor 248 is a particular example of the reference impedance 246 (FIG. 18a) in which the resistance thereof varies with temperature. In addition to the advantage of permitting a device to determine whether a connection impairment is present, the thermistor 248 advantageously provides an indication of temperature when no connection impairment is present, while permitting leak detection and/or moisture content measurements to be performed. Preferably, the variation of resistance with changes in temperature, within an expected temperature range, of the thermistor 248 is small compared to the variation in resistance or impedance of the pair of conductors 236 with changes in moisture content or between the presence and absence of a detectable fluid leak, thereby advantageously providing connection impairment detection and temperature measurement with minimal impact on moisture content and/or leak detection accuracy.

Referring to FIG. 18c, the diode 250 is another particular example of the reference impedance 246 (FIG. 18a) in which the impedance thereof varies with polarity of applied voltage. As is well known in the art, a diode provides a low impedance (e.g. short circuit) when a sufficient voltage is applied in a forward diode direction and provides a high impedance (e.g. open circuit) when a voltage is applied in the opposing reverse diode direction. The diode 250 advantageously permits the determination of a connection impairment when the sufficient voltage is applied in the forward diode direction and advantageously permits the performance of a measurement with minimal or no effect by the diode 250 when a voltage is applied in the reverse diode direction.

Referring to FIG. 18d, the dual reference impedance circuit 252 is a general example of the reference impedance 246 (FIG. 18a) that advantageously presents a first reference impedance when a stimulus having a first polarity is applied and a second reference impedance when a stimulus having a second polarity is applied. By way of example, the first reference impedance may be a precision resistor for use in performing measurements, such as moisture content and/or leak detection measurements, and the second reference impedance may be a thermistor for providing a temperature measurement. By way of further example, the first and second reference impedances may be first and second resistors having different first and second resistance values for providing different first and second sensor output voltage ranges, respectively. By way of further example, the system 10 is advantageously operable to perform a continuity check of the measurement sensor 236, and the first or second reference impedance may have any impedance suitable for performing such continuity check including possibly a fixed resistive impedance such as a minimal or zero ohms resistance. Other circuitry possibilities exist and, in general, each of the first and second reference impedances may be any electrical components or combinations of electrical components. In the embodiment shown in FIG. 18d, one capacitor is in parallel with each diode 251 and each diode 253 to advantageously provide noise suppression, including possibly noise suppression at 50 Hz and/or 60 Hz frequency, which may advantageously enhance measurement and detection accuracy. However, not all embodiments need to have all such capacitors and any number of capacitors may be present or absent from the dual reference impedance circuit 252. While FIG. 18d shows two parallel sub-circuits or paths having two diodes 251 and two diodes 253 in each of the parallel paths of the dual reference impedance circuit 252, any number of one or more diodes in each path may be present in various embodiments of the invention. While FIG. 18d shows the dual reference impedance circuit 252 having two paths thereof, any number of one or more paths may be present in various embodiments. While FIG. 18d shows both paths connected at the terminal end 244 of the pair of conductors 236, in various embodiments both paths may be connected at the connection end 240 of the pair of conductors 236. Additionally or alternatively, one path may be connected at the connection end 240 and the other path connected at the terminal end 244.

Referring to FIGS. 18d and 18e, either or both of the first reference impedance and the second reference impedance shown in FIG. 18d may be implemented as a pair of conductors 236, which may be terminated by a reference impedance 246. By way of exemplary illustration, FIG. 18e shows diodes 251 and diodes 253 arranged at connection ends 240 of two pairs of conductors 236. At the terminal ends 244 of each of the two pairs of conductors 236 is connected a reference impedance 246. Typically the reference impedances 246 have different impedance values Z_{A} and Z_{B} as shown in FIG. 18e. However, in general each of the reference impedances 246 may have any impedance value and preferably have the same or different finite impedance values. Preferably, the reference impedances 246 shown in FIG. 18e are each a single resistive element such as a resistor, including possibly a precision resistor. The reference impedances 246 advantageously permit a data acquisition unit 16 to which the measurement sensor 234 is connected to perform a continuity check or otherwise test for an impaired connection. While not shown in FIG. 18e, in some embodiments capacitors, such as for reducing noise, are included in parallel with one or more of the diodes 251 and 253 in a manner similar to that shown in FIG. 18d.

The two diodes 251 shown in FIG. 18d, and the two diodes 251 shown in FIG. 18e, are directed in the same electrical flow direction as each other. Similarly, the two diodes 253 shown in each of FIGS. 18d and 18e are directed in the same direction as each other. The diodes 251 are directed in the opposing direction to that of the diodes 253, thereby advantageously providing selectivity. In FIG. 18d, reference impedance selectivity is provided, while in FIG. 18e conductor 236 pair selectivity, in conjunction with its respective termination, is provided. In variations, only one diode 251 and/or only one diode 253 need be included in any given path of the measurement sensors 234 shown in FIGS. 18d and 18e to achieve selectivity.

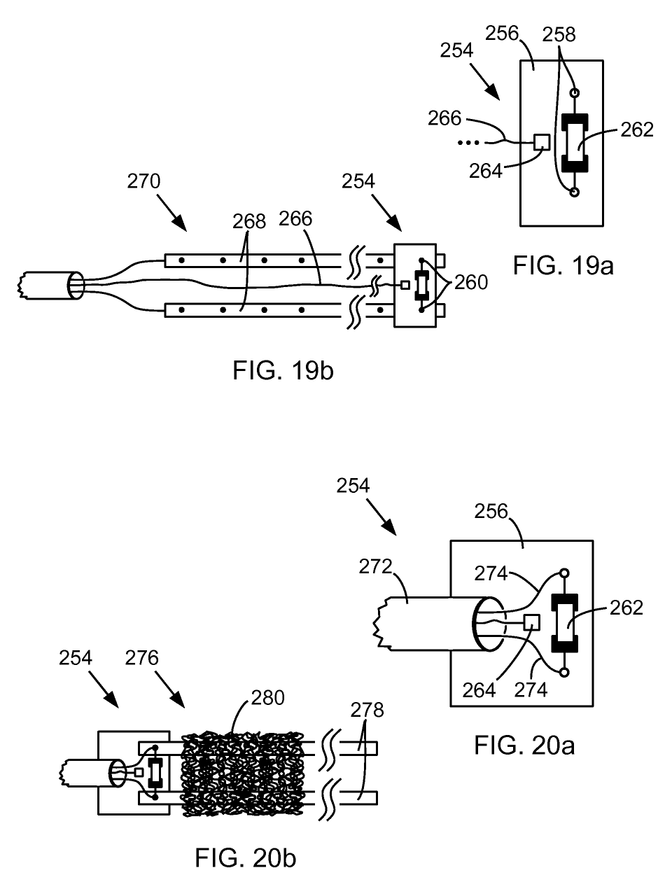

Referring to FIGS. 19a and 19b, a termination module in accordance with embodiments of the invention is shown generally at 254. The termination module 254 includes a base such as the printed circuit board (PCB) 256 having a pair of apertures 258 therethrough for receiving a pair of probes 260. The termination module 254 includes a termination circuit 262 dimensioned for electrical contact with the probes 260 when being received by the termination module 254. In some embodiments, the termination module 254 includes probe supports (not shown) for facilitating electrical contact between probes 260 being received by the termination module 254 and the termination circuit 262. Such probe supports may be implemented in any suitable manner, including as eyelet rivets, PCB vias, metallic linings, or any combination thereof for example. Such probe supports may be attached to the termination module 254 by any suitable technique, including by riveting for example. The termination circuit 262 may be any electrical circuit, including in some embodiments an impedance circuit (FIGS. 18a to 18d) such as the reference impedance 246, thermistor 248, diode 250, dual reference impedance circuit 252, or any combination thereof for example. The termination circuit 262 preferably has a finite impedance, including possibly a nonlinear impedance, such that the termination circuit 262 advantageously permits detection of a connection impairment. Circuit traces of the impedance circuit may be disposed within the PCB 256, coated with an insulating material, or otherwise protected from dust or other undesirable sources of electrical connectivity. In the embodiments shown in FIGS. 19a and 19b, the termination module 254 includes a temperature sensor 264, which may be implemented as a thermistor for example. The temperature sensor 264 is operable to provide an indication of temperature to a connected device by way of the temperature wires 266, which may include any number of wires and/or wired connections.

The pair of probes 260 may be inserted through the pair of apertures 258 into a building 12 material. Wires (not shown in FIGS. 19a and 19b) in electrical contact with each of the probes 260, such as by making electrical contact with electrically conductive portions of the termination circuit 262 at the apertures 258, may be connected, including being connected in conjunction with the temperature wires 266, to a device such as the data acquisition unit 16 (FIGS. 1 and 2), such that the termination module may advantageously be used as a measurement sensor, including as a moisture content and temperature sensor.

However, not all embodiments of the termination module 254 need include wires providing direct electrical contact between a measurement device and the probes 260. In some embodiments, the apertures 258 are dimensioned in various embodiments to correspond to the spacing between conductors of measurement sensors, such as the conductors 268 of the leak detection and moisture content measurement sensor 270 shown in FIG. 19b. The leak detection and moisture content measurement sensor 270 may include an electrically insulating substrate (not shown) for supporting the conductors 268, and such substrate may be adhesive-backed and include a peel-off layer.

When the probes 260 are being received by the apertures 258, the probes 260 are appropriately spaced to make electrical contact with the conductors 268 and are insertable into building 12 material so as to secure the termination module 254 in place. The termination module 254 advantageously provides ease of installation of the termination circuit 262. One or more termination modules 254 may be installed at any location or locations suitable for receiving the pair of probes 260, including at any points along the pair of conductors 218 (FIG. 15), conductors 228 (FIGS. 16 and 17), conductors 236 (FIGS. 18a to 18e) and conductors 268 of the leak detection and moisture content measurement sensor 270. Where the termination module 254 is received by eyelet rivets 230 (FIGS. 16 and 17) of the moisture content sensor 224, such eyelet rivets 230 are preferably in transverse alignment with each other.

Referring to FIG. 20a, the termination module 254 includes in some embodiments a cable housing 272 for housing the termination circuit wires 274 and the temperature wires 266. The cable housing 272 advantageously facilitates use of the termination module 254 as a moisture content and/or temperature sensor. In general, either or both of the termination circuit 262 and the temperature sensor 264 may be included in the termination module 254. The cable housing 272 and termination circuit wires 274 arrangement advantageously facilitates use of the termination module 254 to provide a connection between a measurement device and a connection end of any one or more of the encloseable moisture content sensor 214 (FIG. 15), moisture content sensor 224 (FIGS. 16 and 17), the measurement sensor 234 (FIGS. 18a to 18e) and the leak detection and moisture content measurement sensor 270 (FIG. 19b). However, the termination module 254 may be located at any point along such sensors.

FIG. 20b shows a condensation sensor 276 to which the termination module 254 having the exemplary cable housing 272 is shown attached. In various embodiments, the condensation sensor 276 may include the termination module 254 attached at any point along the condensation sensor 276, including at either end thereof. In some embodiments, the condensation sensor 276 does not include a termination module 254. The condensation sensor 276 may, but need not, include probes (not shown in FIG. 20b) for measuring moisture content within a building 12 material. In various embodiments, one or more termination modules 254, each of which being with or without the cable housing 272, are attachable at any point(s) along any one or more of the encloseable moisture content sensor 214 (FIG. 15), moisture content sensor 224 (FIGS. 16 and 17), the measurement sensor 234 (FIGS. 18a to 18d), the leak detection and moisture content measurement sensor 270 (FIG. 19b) and the condensation sensor 276.

The condensation sensor 276 includes a pair of spaced apart conductors 278, and a layer of non-hydrophobic material 280 in physical contact with the respective top surfaces of the conductors of the pair 278. The non-hydrophobic material 280 is preferably electrically insulating, and may be made of a woven or fibrous material, such as a woven polymer. The non-hydrophobic material 280 may be made of a polyester, for example. The non-hydrophobic material 280 may have any length, including a calibrated or otherwise specifiable length for example. The non-hydrophobic material 280 may extend along any portion of the pair of conductors 278, including extending along the entire length of the pair of conductors 278. The non-hydrophobic material 280 is preferably suitable for collecting moisture external to a building 12 material, such as moisture produced by condensation, and typically does so by providing an increased surface area where fluid or other moisture may collect. Typically, the non-hydrophobic material 280 is also non-hygroscopic such that collected moisture is not absorbed by the non-hydrophobic material 280, thereby facilitating the detection by the condensation sensor 276 of the collected moisture. Such non-hydrophobic material 280 advantageously permits any sensor having exposed conductors to which the non-hydrophobic material 280 is attached, including any one or more of the measurement sensor 234, leak detection and moisture content measurement sensor 270 and the condensation sensor 276, to provide a measurement result indicative of condensation.

In various embodiments, any one or more of the encloseable moisture content sensor 214 (FIG. 15), moisture content sensor 224 (FIGS. 16 and 17), measurement sensor 234 (FIGS. 18a to 18d) and leak detection and moisture content measurement sensor 270 (FIGS. 19b and 20b) or other similar sensor can be connected to one or more devices such as the data acquisition units 16 (FIGS. 1 and 2) and adhered to a surface, such as a wall, floor, ceiling and/or roof of the building 12 (FIG. 1). For example, a sensor can be laid along the base of a wall to detect fluid leaking down the wall as it arrives at the floor. One or more sensors may be laid in a rectangular grid along a floor, ceiling or roof member. Where a building 12 surface, such as a horizontally disposed floor or ceiling for example, has a corrugated surface or other grooves to direct fluid flow longitudinally, then spaced apart sensors can be laid laterally, including parallel to each other, to detect such longitudinal fluid flow. Where a building 12 surface is sloped such that gravitationally induced fluid flow is likely to occur in a downward direction, then one or more spaced apart sensors can be laid perpendicular to such downward direction to detect such downward fluid flow, possibly in conjunction with a pair of sensors oriented parallel to the downward direction and disposed at opposing ends of such sloped building 12 surface.

Additionally or alternatively, any one or more of the encloseable moisture content sensor 214 (FIG. 15), moisture content sensor 224 (FIGS. 16 and 17), measurement sensor 234 (FIGS. 18a to 18e) and leak detection and moisture content measurement sensor 270 (FIGS. 19b and 20b) or other similar sensor can be connected to one or more devices such as the data acquisition units 16 (FIGS. 1 and 2) and adhered to a surface of a fixture of the building 12 (FIG. 1), such as a plumbing fixture, including possibly a plumbing pipe or other conduit, equipment, including housings of equipment, and other fixtures. In general, the inventive system, apparatus, method and sensors for monitoring structures described or illustrated herein is not limited to building structures and may be suitably used for monitoring other structures such as equipment, infrastructure, and other items where moisture may be of concern. For example, any one or more of the sensors described or illustrated herein may be suitably used for monitoring the condition of a pipe (not shown). In such example, the temperature and external surface moisture of the pipe may be monitored, such as by wrapping a sensor around the pipe and transmitting measurement results to the gateway 18 (FIG. 1) for analysis. Such analysis may include predictive analysis in which the likelihood that the pipe will develop a leak, such as by forming a crack in the material of the pipe due to freezing temperatures, an accumulation of moisture and/or condensation on the surface of the pipe, or any combination thereof, is determined.

Any one or more of the encloseable moisture content sensor 214 (FIG. 15), moisture content sensor 224 (FIGS. 16 and 17), measurement sensor 234 (FIGS. 18a to 18e) and leak detection and moisture content measurement sensor 270 (FIGS. 19b and 20b) or other similar sensor may be suitably used in producing measurement results that can be reported by the system 10 to a user as a moisture content measurement specific to any particular type of material, such as a material having a known moisture transfer characteristic for example, as a moisture level measurement particularly suitable for general materials, such as concrete, gypsum, masonry or other aggregate materials, or any combination thereof for example.

Any one or more of the encloseable moisture content sensor 214 (FIG. 15), moisture content sensor 224 (FIGS. 16 and 17), measurement sensor 234 (FIGS. 18a to 18e) and leak detection and moisture content measurement sensor 270 (FIGS. 19b and 20b) or other similar sensor may be used with or without any one or more of the probe 232, probe 242, pair of probes 260, or any combination thereof. Any one or more of the probe 232, probe 242, pair of probes 260 may include a non-isolated probe, in which the entire length thereof is conductive, or an isolated probe in which a specific portion thereof is conductive, thereby permitting the association of a measurement result with a specifiable depth into a material, for example.

Any one or more of the encloseable moisture content sensor 214 (FIG. 15), moisture content sensor 224 (FIGS. 16 and 17), measurement sensor 234 (FIGS. 18a to 18e) and leak detection and moisture content measurement sensor 270 (FIGS. 19b and 20b) may be connected to measurement sensor connector 32 (FIG. 3). For example, the sensor connected to the measurement sensor connector 32 may include a reference impedance, which may be a 20 mega-ohm resistor for example, at the terminal end of such sensor, thereby forming an exemplary terminated circuit which advantageously may be suitable for continuity testing and have improved measurement accuracy and/or an extended measurement range. A reference impedance or reference circuit attached to a sensor connected to the measurement sensor connector 32 may advantageously form a half-bridge circuit in conjunction with the sensor circuitry 42 (FIG. 3).

Thus, there is provided a measurement sensor for detecting moisture, which includes: (a) a pair of spaced apart conductors; and (b) an impedance circuit electrically connectable in parallel with said pair of conductors and having a finite impedance such that when said impedance circuit is connected an impedance of said measurement sensor greater than said finite impedance indicates an impaired connection.

In accordance with another aspect of the invention, there is thus provided a termination module for a moisture detection measurement sensor, the sensor comprising a pair of spaced apart conductors, the termination module comprising: (a) a base attachable to the sensor; and (b) an impedance circuit supported by said base such that said impedance circuit is electrically connected in parallel with the pair of conductors when said base is attached to the sensor, said impedance circuit having a finite impedance such that when said base is attached to the sensor an impedance of said measurement sensor greater than said finite impedance indicates an impaired connection.

In accordance with another aspect of the invention, there is thus provided a moisture content measurement sensor for measuring moisture content of a structural material, the moisture content measurement sensor comprising: (a) a pair of spaced apart conductors enclosed within an electrically insulating material; and (b) a plurality of electrically conductive probe supports, each said probe support being attached to one of said conductors and dimensioned to receive a probe for insertion into the structural material, said each probe support forming an electrical connection between said one conductor and said probe.

While embodiments of the invention have been described and illustrated, such embodiments should be considered illustrative of the invention only. The invention may include variants not described or illustrated herein in detail. For example, although not shown in FIG. 2 for simplicity of illustration, the data acquisition unit 16 may include in various embodiments additional control lines between the processor 22 and other components of the data acquisition unit 16, such as the internal temperature sensor 26, internal pressure sensor 28, interface circuit 34, measurement sensor switch 38, sensor circuit 40, measurement result switch 64, wireless transceiver 66, bus transceiver 48, bus switch 72, power mode switch 58 and/or the auxiliary power switch 84, to facilitate control by the processor 22 of operations of the data acquisition unit 16. Thus, the embodiments described and illustrated herein should not be considered to limit the invention as construed in accordance with the accompanying claims.

What is claimed is:

1. A system for monitoring a structure, the system comprising a measurement acquisition unit having first and second connection points, said measurement acquisition unit being operable to receive at said first connection point a sensor unit electrically connected to the structure, said measurement acquisition unit being operable to receive at said second connection point an electrical connection to the structure, said measurement acquisition unit being operable to electrically isolate said second connection point from said first connection point when invoking said sensor unit so as to produce a measurement result for monitoring the structure.

2. The system of claim 1 wherein said electrical connection comprises a wired communications bus for wired communications with a monitoring center, said measurement acquisition unit being operable to communicate said measurement result to said monitoring center via said wired communications.

3. The system of claim 1 wherein said measurement acquisition unit comprises a third connection point for receiving a distributed power wire, said measurement acquisition unit being operable to electrically isolate said second and third connection points from said first connection point when invoking said sensor unit so as to produce said measurement result.

4. The system of claim 1 wherein said electrical connection comprises a distributed power wire for supplying power to said measurement acquisition unit, said measurement acquisition unit being operable to establish an auxiliary power source for powering said measurement acquisition unit while said measurement acquisition unit is electrically isolated from said distributed power wire.

5. The system of claim 1 wherein said measurement acquisition unit is operable to communicate said measurement result via wireless communications, said measurement acquisition unit being operable to select, from among one or more available recipients, a recipient for receiving said measurement result from said measurement acquisition unit, said measurement acquisition unit selecting said recipient such that the number of transmissions required to communicate said measurement result to a monitoring center is minimized.

6. The system of claim 5 wherein said measurement acquisition unit is operable to select said recipient so as to maximize signal strength of communications with said recipient if a plurality of said available recipients have associated therewith a same minimal number of transmissions required for communicating said measurement result from said measurement acquisition unit to said monitoring center.

7. The system of claim 1 wherein said measurement acquisition unit is operable to set, in response to said measurement result, an amount of time to elapse before producing a subsequent measurement result.

8. The system of claim 1 comprising a plurality of said measurement acquisition units, said plurality of said measurement acquisition units comprising a first said measurement acquisition unit wherein said electrical connection comprises a wired communications bus for wired communications with a monitoring center, said plurality comprising a second said measurement acquisition unit being operable to communicate said measurement result via wireless communications to a recipient selected from among available said measurement acquisition units, said second measurement acquisition unit selecting said recipient such that the number of transmissions required to communicate said measurement result to said monitoring center is minimized.

9. The system of claim 8 wherein said second measurement acquisition unit is operable to select said recipient so as to maximize signal strength of communications with said recipient if a plurality of said available measurement acquisition units have associated therewith a same minimal number of transmissions required for communicating said measurement result from said second measurement acquisition unit to said monitoring center.

10. The system of claim 9 wherein the structure defines one or more faces and wherein said first measurement acquisition unit and said second measurement acquisition unit are located adjacent one said face.

11. The system of claim 10 wherein said first measurement acquisition unit and said second measurement acquisition unit are aligned for line-of-sight communication therebetween.

12. A system for monitoring a structure, the system comprising:
(a) measurement acquisition means for producing measurement results, said measurement acquisition means comprising first connection means for receiving a sensor unit electrically connected to the structure, said measurement acquisition means comprising second connection means for receiving an electrical connection to the structure; and
(b) isolation means for electrically isolating said second connection means from said first connection means when invoking said sensor unit so as to produce said measurement results.

13. The system of claim 12 wherein said measurement acquisition means comprises wired communication means for communicating said measurement results via wired transmission and comprises wireless communication means for communicating said measurement results via wireless transmission.

14. The system of claim 12 wherein said measurement acquisition means comprises internal powering means for powering said measurement acquisition means when invoking said sensor unit.

15. An apparatus for producing a measurement result to facilitate monitoring a structure, the apparatus comprising:
(a) a first connector for receiving a sensor unit electrically connected to the structure;
(b) a second connector for receiving an electrical connection to the structure; and
(c) a switch for electrically isolating said second connector from said first connector when invoking said sensor unit so as to produce the measurement result.

16. The apparatus of claim 15 comprising a wired communication transceiver for communicating the measurement result to a monitoring center via wired transmission when a wired communications bus is connected to said second connector.

17. The apparatus of claim 15 further comprising a third connector for receiving a distributed power wire for supplying power to the apparatus, said switch being operable to electrically isolate said second and third connectors from said first connector when invoking said sensor unit so as to produce the measurement result.

18. The apparatus of claim 15 wherein said electrical connection comprises a distributed power wire for supplying power to the apparatus, the apparatus further comprising an auxiliary power source for powering the apparatus when said switch is electrically isolating said second connector from said first connector.

19. The apparatus of claim 18 wherein said auxiliary power source comprises a capacitor.

20. The apparatus of claim 15 comprising a wireless communication transceiver for communicating the measurement result via wireless transmission.

21. The apparatus of claim 15 comprising a sensor circuit operable to selectively invoke a reference resistance, the apparatus being operable to receive a measurement sensor comprising a pair of spaced apart conductors and an impedance circuit electrically connected in parallel with said pair of conductors, said impedance circuit having a finite impedance.

22. A method of monitoring a structure, the method comprising:
(a) receiving at a first connector of a measurement acquisition unit a sensor unit electrically connected to the structure; and
(b) invoking said sensor unit so as to produce a measurement result for monitoring the structure,
wherein invoking said sensor unit so as to produce a measurement result for monitoring the structure comprises electrically isolating a second connector of said measurement acquisition unit from said first connector.

23. The method of claim 22 further comprising receiving at said second connector a wired communications bus for communicating said measurement result to a monitoring center via wired transmission.

24. The method of claim 22 further comprising receiving at a third connector of said measurement acquisition unit a distributed power wire for supplying power to said measurement acquisition unit, and wherein electrically isolating a second connector of said measurement acquisition unit from said first connector when invoking said sensor unit comprises electrically isolating said second and third connectors from said first connector when invoking said sensor unit.

25. The method of claim 22 further comprising receiving at said second connector a distributed power wire for supplying power to said measurement acquisition unit, and wherein electrically isolating a second connector of said measurement acquisition unit from said first connector when invoking said sensor unit comprises establishing an auxiliary power source for powering said measurement acquisition unit.

26. The method of claim 25 wherein establishing an auxiliary power source for powering said measurement acquisition unit comprises charging a capacitor by power received from said distributed power wire.

27. The method of claim 22 further comprising:
(a) determining a number of available recipients operable to receive said measurement result from said measurement acquisition unit via wireless communication;
(b) if there are one or more said available recipients, selecting a recipient from among said one or more available recipients; and
(c) if there are no said available recipients, storing in a memory of said measurement acquisition unit said measurement result and a measurement count in association therewith.

28. The method of claim 27 wherein if there are one or more said available recipients, selecting a recipient from among said one or more available recipients comprises selecting said recipient such that the number of transmissions required to communicate said measurement result from said measurement acquisition unit to a monitoring center is minimized.

29. The method of claim 28 wherein selecting said recipient such that the number of transmissions required to communicate said measurement result to a monitoring center is minimized comprises, if a plurality of said available recipients have associated therewith a same minimal number of transmissions required to communicate said measurement result from said measurement acquisition unit to said monitoring center, selecting said recipient such that signal strength of communications between said recipient and said measurement acquisition unit is maximized.

30. The method of claim 27 further comprising transmitting by said measurement acquisition unit to said recipient via wireless communication said measurement result and any previously stored measurement results and associated measurement counts not previously transmitted by said measurement acquisition unit.

31. The method of claim 22 further comprising receiving by a second measurement acquisition unit said measurement result, and transmitting by said second measurement acquisition to a monitoring center via wired communication said measurement result.

32. The method of claim 22 further comprising setting, in response to said measurement result, an amount of time to elapse before producing a subsequent measurement result.
